(19) United States
(12) Patent Application Publication
(10) Pub. No.: US 2025/0217193 A1
(43) Pub. Date: Jul. 3, 2025

(54) SYSTEMS AND METHODS TO PROVIDE PARAMETER-EFFICIENT FINE-TUNED MODELS

(71) Applicant: Adobe Inc., San Jose, CA (US)

(72) Inventors: Yuanyou Wang, San Jose, CA (US); Naveen Vangala, San Jose, CA (US); Mayank Anand, San Jose, CA (US); Kunal Kumar Jain, San Jose, CA (US); Jose Mathew, San Jose, CA (US); Eapen Jose, San Jose, CA (US); Divyanshu Goyal, San Jose, CA (US); Asmita Chihnara, San Jose, CA (US); Arif Abdullah, San Jose, CA (US); Anand Dantu, San Jose, CA (US)

(73) Assignee: Adobe Inc., San Jose, CA (US)

(21) Appl. No.: 18/397,393

(22) Filed: Dec. 27, 2023

(51) Int. Cl. G06F 9/50

(52) U.S. Cl. CPC G06F 9/5027

(57) ABSTRACT

Embodiments are directed to systems and techniques to process inference requests in a fine-tuned model environment. Embodiments include receiving a request to perform a task using the fine-tuned model. Determining whether an instance of the fine-tuned model, which includes a specific layer identified by a model instance identifier, is currently executing in an orchestration platform's environment. If the instance of the fine-tuned model is not currently executing, embodiments include proceeding to load the identified layer into a base model within the environment. This process generates an instance of the fine-tuned model to perform the requested task.

### BACKGROUND

Traditional ML models often require significant computational resources and a large number of parameters to achieve high performance in complex tasks. However, these models can be resource-intensive, making them impractical for deployment on low-power devices or in situations with limited computational resources. In the fast-paced domain of machine learning, the deployment and serving of models for real-time inferences is a daunting task and efficient training and storage of specialized, fine-tuned models add an extra layer of complexity. A key issue emerges when multiple applications demand distinct, fine-tuned variations of a shared foundation model. Traditional methods of serving these specialized models usually require the hosting of individual instances for each variant, despite these variants sharing a large part of their architecture with a universal foundation model. These traditional approaches present multiple challenges, including resource inefficiencies, high network costs, latency, operational complexity, and model training overhead.

### BRIEF SUMMARY

Embodiments are directed to systems and techniques performed by an orchestration platform to execute a task using a fine-tuned model. Specifically, the orchestration platform receives a request to perform a task with a specific fine-tuned model. This request includes a model instance identifier. The platform determines if an instance of the fine-tuned model, which includes a layer identified by the model instance identifier, is already executing within its environment. If the instance of the fine-tuned model is already executing in the platform's environment, the platform proceeds to process the task using that instance. If an instance of the fine-tuned model including the layer is not executing in the environment, the platform retrieves the layer identified by the model instance identifier from a data store. In embodiments, this layer is pre-trained with data associated with the task. The platform loads the retrieved layer into a base model, which is pre-trained on data, to generate the instance of the fine-tuned model including the layer. Further, the platform initiates the fine-tuned model including the loaded layer in the environment. Finally, the platform processes the task using the instance of the fine-tuned model. To summarize, this method allows the orchestration platform to determine if a particular fine-tuned model is already executing. If it is, the platform proceeds with the task. Otherwise, it retrieves the appropriate layer, loads it into a base model, initiates the environment, and processes the task using the fine-tuned model instance.

Embodiments discussed herein may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates a routine 600 in accordance with one embodiment.

FIG. 7 illustrates a routine 700 in accordance with one embodiment.

FIG. 8 illustrates a routine 800 in accordance with one embodiment.

FIG. 9 illustrates a routine 900 in accordance with one embodiment.

FIG. 10 illustrates a system 1000 in accordance with one embodiment.

FIG. 11 illustrates an apparatus 1100 in accordance with one embodiment.

FIG. 12 illustrates an artificial intelligence architecture 1200 in accordance with one embodiment.

FIG. 13 illustrates an artificial neural network 1300 in accordance with one embodiment.

FIG. 14 illustrates a computer-readable storage medium 1402 in accordance with one embodiment.

FIG. 15 illustrates a computing architecture 1500 in accordance with one embodiment.

FIG. 16 illustrates a communications architecture 1600 in accordance with one embodiment.

### GLOSSARY

“Cache” refers to a temporary storage location for data that is frequently accessed.

“Cluster system” refers to a group of computers that are connected together and work as one system

“Container” refers to software that includes everything needed to run an application or model: code, runtime, system tools, system libraries and settings.

“Environment” refers to a software-defined environment that provides computing resources, such as CPU, memory, and storage, on demand. The environment is created on top of physical infrastructure.

“Base model” refers to a model that has been trained on a general dataset.

“Fine-tuned model” refers to a pre-trained base model that includes additional layers further trained on a new dataset specific to a particular task.

“General dataset” refers to a collection of data that is diverse and covers a broad range of information or observations.

“Inference” refers to the process and result of using a trained model to make predictions or decisions about new, unseen data.

“Layer” refers a model component that process input data and transform it into meaningful output.

“Model identifier” refers to any identifier to identify a base model

“Model instance identifier” refers to an identifier to identify one or more layers for a model.

“Orchestration platform” refers to a system or tool that helps coordinate and manage the execution of multiple tasks, processes, or services in a workflow.

“Specific dataset” refers to a collection of data that is defined by certain characteristics, parameters, or criteria. Unlike a general dataset, which may encompass a broad range of information, a specific dataset is focused on a particular topic, domain, or set of variables.

“Cluster level cache” refers to memory at the cluster level.

“Host level cache” refers to memory at the host, virtual, and/or container level.

### DETAILED DESCRIPTION

Embodiments are generally directed to systems and techniques to sufficiently serve fine-tuned models, such as a Parameter Efficient Fine-Tuned (PEFT) model, in an efficient manner. In typical machine learning applications, there is often a need to serve various incarnations of a single foundation or base model to accommodate a range of distinct use cases. Although the base model remains unchanged, the fine-tuned layers, such as Low-Rank Adaptation (LoRA) layers, vary according to specialized needs. Traditionally, addressing this challenge includes serving complete replicas of each model variant, thus accruing considerable network, storage, and computational overhead. Embodiments discussed herein present a transformative approach that includes the capability for training the LoRA layers tailored to specific tasks. Once trained, these layers are stored separately in a data store, such as Blob Storage, obviating the need to replicate the entire foundation or base model for each variant. In this architecture, a pre-loaded container harboring the foundation model is kept running to expedite service. When an inference request arrives, the system dynamically fetches a corresponding LoRA layer from the data store in real-time and loads or injects it into the pre-loaded base model container to generate instant inferences. This mechanism not only drastically minimizes network data transfer costs and container startup time but also offers a highly efficient, scalable, and economically viable system for serving fine-tuned machine learning models.

In the fast-paced domain of machine learning, the deployment and serving of models for real-time inferences is a daunting task and efficient training and storage of specialized fine-tuned models adds an extra layer of complexity. A key issue emerges when multiple applications demand distinct, fine-tuned variations of a shared foundation model. Traditional methods of serving these specialized models usually require the hosting of individual instances for each variant, despite these variants sharing a large part of their architecture with a universal foundation model. This traditional approach presents multiple challenges. For example, the practice of hosting each model variant as a separate instance necessitates the duplication of the common base layers, leading to a wasteful consumption of storage and memory resources. This cost to serve each new fine-tuned model goes up linearly.

Further, the process of transferring complete model instances across the network for each request, including the static foundation model layers, significantly bloats network bandwidth and drives up operational costs. Additionally, initializing a new container for every model variant and loading the complete model into memory contributes to delays, negatively affecting both response time and system throughput. This can take minutes and makes it hard to serve real-time use cases in a cost-effective manner. In addition, the administrative burden of managing multiple closely related model instances increases the intricacy of system operations, affecting aspects such as versioning, updates, and fault tolerance. Further, traditional fine-tuning procedures demand a multi-step initialization process, including booting up a container, installing the necessary dependencies, and loading the foundation model. These steps must be completed before even beginning to fine-tune the specialized layer, such as a LoRA layer. This approach adds significant overhead in terms of time, computational resources, and operational complexity.

Embodiments discussed herein describe an approach aimed at transforming the efficiency and efficacy of training and serving fine-tuned machine learning models. These vital contributions set systems discussed herein apart from existing solutions and underline their innovative character. For example, embodiments discussed herein enable the targeted training of a specific layer, such as a LoRA layer, eliminating the cumbersome initialization steps traditionally required for fine-tuning. This includes bypassing the need to boot up a container, install dependencies, and load the foundation model, significantly reducing overhead and accelerating the fine-tuning process. Improvements also include dynamically retrieving a layer, such as the fine-tuned LoRA layer, from storage during real-time inference. This innovative approach removes the necessity to load the full model, thus markedly reducing network data transfer costs.

Embodiments further include preloading a foundation or base model in a computing environment, such as a container. Specifically, a running container houses the pre-loaded foundation model, enabling the real-time integration of a dynamically fetched LoRA layer for immediate inference. This mechanism significantly trims down container setup time, thereby enhancing system throughput. Further, by storing the LoRA layer separately and leveraging a shared foundation or base model, a system realizes optimal usage of storage and memory resources. This translates to reduced operational expenses.

Further, the system is designed to be scalable, the architecture can proficiently serve a multitude of fine-tuned models without affecting the performance of the base or derived models. Additionally, the operational complexity is simplified as the system centralizes at least a portion of the management of a universal foundation model while decentralizing the LoRA layers and monitoring thereof. This centralization eases the tasks of updating, versioning, and maintaining the fine-tuned models. Further, real-time fetching of LoRA layers equips the system with the capability to adapt dynamically to model updates or freshly fine-tuned variants. This feature ensures seamless deployment of updates without downtime. Although tailored for machine learning models, embodiments discussed herein can be adapted to other computational frameworks that include a common foundation model and multiple specialized variants. This extends the system's range of applications. Further, eliminating the need to load an entire model for every request minimizes latency—a vital aspect for applications demanding real-time responses, like autonomous driving or medical diagnostics.

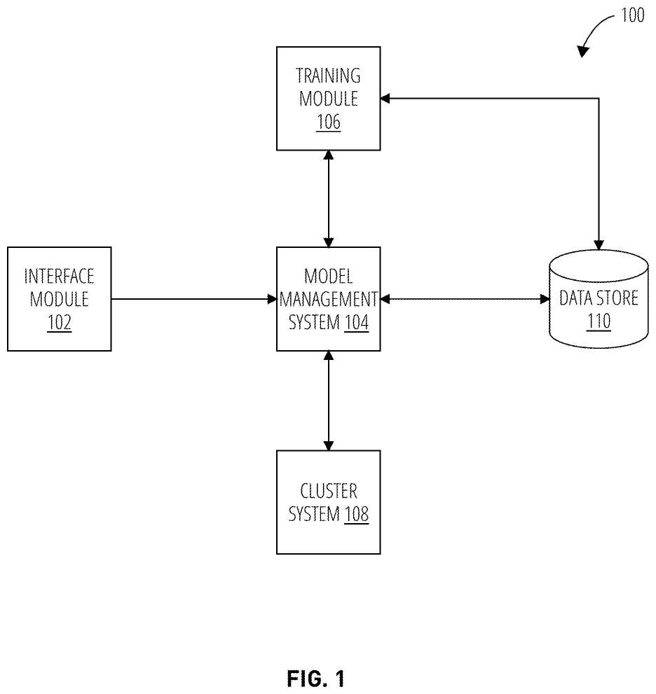

FIG. 1 illustrates an example configuration of an orchestration platform 100 in accordance with embodiments. The orchestration platform 100 includes components and modules to process machine-learning requests with fine-tuned models. The orchestration platform 100 includes a framework that enables the coordination, scheduling, and management of complex tasks and processes in a distributed computing environment. Specifically, the orchestration platform 100 includes a number of systems, modules, and components that operate on computer resources, such as servers having circuitry and memory, networking components, and data stores. In instances, the orchestration platform 100 is implemented as a cloud-computing environment. The cloud computing environment includes virtualization resources to create virtual instances of servers, storage, and other resources. In one example, the orchestration platform 100 utilizes Kubernetes®, Docker®, etc. containers as virtual environments to host the fine-tune models. Virtualization allows for the efficient utilization of the physical hardware, enabling multiple virtual machines or containers to run on one or more physical servers.

In embodiments, the orchestration platform 100 includes a training module 106 providing model training for the fine-tuned models discussed herein. The training module 106 trains one or more base models to generate trained fine-tuned models, which include a base model and one or more layers. In some instances, the training module 106 first trains a base model to generate a trained base model, and then trains the trained base model to generate a fine-tuned model. In embodiments, the training module 106 trains and generates base models using large, general datasets to learn general patterns and features. In one example, the training module 106 trains on a task or domain, such as image recognition or natural language processing, using a vast amount of labeled data to generate a trained base model that can be further fine-tuned. A base model captures general patterns from diverse data sources. Further, the base model is the initial model architecture and includes parameters before any fine-tuning. Thus, the base model is a fine-tuned model without one or more fine-tuned layers including architecture and parameters generated during the fine-tuning process.

The training module 106 performs additional training on the base models, e.g., fine-tuning the base model, to generate a finalized fine-tuned model. Specifically, the training module 106 trains or adapts the base model trained on the larger dataset with a smaller, specific dataset relevant to a specific task to generate the finalized fine-tuned model. The fine-tuning process helps the model leverage the knowledge gained from the large pre-training or general dataset and adapts the model to perform well on a narrower task or domain. By training on a smaller dataset, the fine-tuning process allows the model to learn task-specific features and nuances. In embodiments, the training module 106 trains or fine-tunes the base model a number of times on different smaller, domain-specific data set(s) that are relevant to the specific task. The fine-tuning generates or determines one or more parameters for one or more model layers. Fine-tuning involves adjusting the model's hyperparameters, freezing certain layers to preserve the pre-trained knowledge, and training the remaining layers on the task-specific dataset. The fine-tuning process allows the model to converge to a solution that performs well on the target task while benefiting from the general features learned during pre-training or general training phase. In embodiments, the orchestration platform 100 stores each of the trained base models and the one or more finely-tuned layers in storage. For example, the training module 106 stores a base model in the data store 110 with an associated model identifier and one or more fine-tuned layers with an associated model instance identifier.

The orchestration platform 100 including the training module 106 provides base models in many different categories, each having a number of species (fine-tuned models with tuned layers). The orchestration platform 100 identifies each of the base models by a model identifier, as previously mentioned. The model identifier is any unique alphanumeric identifier capable of identifying a model. In embodiments, components of the orchestration platform 100 store and retrieve a base model utilizing the model identifier. In one example, the training module 106 receives and processes a request, including a model identifier, to fine-tune an associated base model. In some instances, the request includes additional information, such as training configuration data to use to train the base model. The training module 106 fine-tunes the model and generates one or more layers, including one or more parameters finely tuned based on the specific training set and configuration data. The training module 106 identifies one or more layers with a model instance identifier. Similarly, the model instance identifier is also any combination of alphanumeric characters that can uniquely identify one or more layers.

In embodiments, the orchestration platform 100 includes a data store 110 to store data. The data store 110 is a storage system to store and manage various types of data. It serves as a centralized repository where data can be collected, organized, and retrieved. The data store 110 stores the data in one or more of databases, file systems, cloud storage, or any other mechanism used for storing and retrieving data. It offers functionalities like data persistence, data retrieval, and data management, enabling efficient and secure access to stored information.

In one example, the data store 110 is a Binary Large Object (blob) storage, which is a collection of binary data that is stored as a single entity. The Blob storage allows for the storage and management of unstructured data, such as images, videos, documents, and other file types, e.g., model data. Unlike traditional file systems or databases that organize data in a hierarchical structure, blob storage treats data as individual, distinct objects. Each object, or blob, is typically identified by a unique identifier or key. Blob storage provides scalable and durable storage to handle massive amounts of data, making it suitable for applications requiring large-scale data storage and retrieval, e.g., model data. In embodiments, the blob storage provides high availability, redundancy, and security features to ensure data integrity and accessibility. In some instances, the blob storage provides specific features such as data versioning, encryption, and the ability to define access policies.

In embodiments, the data store 110 stores model data for models with an associated identifier. For example, the data store 110 store base models with associated model identifiers. Other components or modules of the orchestration platform 100 utilize the model identifier to retrieve and/or store the model data associated with a particular model. For example, the training module 106 retrieves a base model with an associated model identifier. As discussed, the training module 106 can perform fine-tuning operations on the base model. In another example, the data store 110 stores layers for fine-tuned models with associated model instance identifiers. Similarly, modules of the orchestration platform 100 use the model instance identifiers to store and retrieve layers to perform operations. For example, the model management system 104 uses the model instance identifiers to retrieve particular layers to load into an executing model on the cluster system 108 to perform instance operations.

The orchestration platform 100 also includes a model management system 104. The model management system 104 manages the overall processes for the orchestration platform 100. Specifically, the model management system 104 processes requests for inferences from customer systems, and provides results for the inference requests once processing is completed by the cluster system 108. The model management system 104 includes the software or hardware infrastructure that facilitates the development, deployment, and maintenance of machine learning models discussed herein. It provides a centralized platform to manage the entire lifecycle of models, including tasks such as data preprocessing, training, evaluating, deploying, versioning, and monitoring of models.

In embodiments, the model management system 104 includes components that collectively facilitate the development, deployment, and maintenance of machine learning models. In some embodiments, the model management system 104 includes and/or is coupled with an interface module 102 providing one or more application programming interface(s) (APIs) utilized by the customer systems to submit inference requests. In some instances, the model management system 104 provides data ingestion functions that collects, cleans, and prepares the data for models. These functions ensure that the input data is properly formatted and ready for analysis. The model management system 104 also evaluates model performance and accuracy after training. For example, the model management system 104 assesses metrics, such as accuracy, precision, recall, and F1 score, to determine how well the models perform on test datasets.

In embodiments, the model management system 104 also deploys models once they have been trained and evaluated. The model management system 104 integrates the models into the software infrastructure or creates a standalone service for their utilization e.g., storing the models in the data store 110 and deploying the models in the cluster system 108 to process data.

In one example, the model management system 104 processes requests for inferences. The model management system 104 determines if a fine-tuned model, including one or more layers trained for the specific inference request, is executing in the cluster system 108. If so, the model management system 104 schedules the request for processing by the cluster system 108 and returns a result to the requesting system once the cluster system 108 processes the request. If an instance of the fine-tuned model is not executing on the cluster system 108, the model management system 104 determines one or more layers in the data store 110 for processing the request and initiating a fine-tuned model including the one or more layers on the cluster system 108. Once processed, the model management system 104 returns a result of the request.

The model management system 104 also monitors performance and reliability. For example, the model management system 104 tracks model behavior, detects anomalies and identifies performance degradation or concept drift. The model management system 104 ensures that the models remain effective and their predictions remain accurate. In embodiments, the model management system 104 also monitors and manages different versions of machine learning models is vital for experimentation, reproducibility, and maintaining a history of model performance. For example, the model management system 104 saves data associated with versioning and management in a data store. In some instances, the model management system 104 provides the data to the customer's and/or operators' systems. This enables practitioners to track changes, compare different versions, roll back to previous versions, and collaborate effectively. In embodiments, the model management system 104 includes a retraining and maintenance functionality. Machine learning models often require periodic retraining to adapt to evolving data patterns or changes in the underlying problem space. The model management system 104 schedules and executes regular retraining cycles to keep the models up to date and maintain their performance over time.

The orchestration platform 100 includes a cluster system 108 to execute fine-tune models to perform inference operations. In some instances, the cluster system 108 executes one or more base models that are capable of being loaded or deployed with one or more layers specifically tailored for a particular inference request. In one example, the cluster system 108 is an Azure® cluster. However, other cluster platforms may be utilized in accordance with embodiments discussed herein. The cluster system 108 includes a grouping of interconnected computing resources that operates a cloud computing platform and service. In instances, cluster system 108 is configured to provide a scalable and reliable infrastructure for running various applications and workloads to process inferences. In embodiments, the cluster system 108 includes multiple virtual machines (VMs) or instances that are deployed in a specific region or availability zone. These VMs are connected through a common network and are organized in a way that allows them to work together to achieve specific goals, such as high availability, improved performance, or fault tolerance.

In embodiments, the virtual machines can provide one or more containers, such as Kubernetes®. The cluster system 108 automates the management, scaling, and deployment of containerized applications. In one configuration, the cluster system 108 groups the containers together to form applications or microservices. The cluster system 108 manages these containerized applications by providing a robust set of features and capabilities. The cluster system 108 automates container deployment, scaling, and management across a cluster of nodes. It ensures that the desired state of applications is maintained, monitors their health, and automatically restarts failed containers. The cluster system 108 ensures that applications are highly available by distributing containers across multiple nodes and automatically scaling them up or down based on resource usage or predefined criteria. Additionally, the cluster system 108 provides an internal domain name service (DNS) system, load balancing, and routing capabilities to efficiently distribute traffic to containers and enable easy service discovery within the cluster. The cluster system 108 enables horizontal scaling of applications by adding or removing container replicas based on resource utilization or custom-defined metrics. Auto-scaling features ensure that applications can handle varying traffic demands efficiently. In embodiments, the cluster system 108 handles volume and storage management for applications, allowing them to dynamically use different types of storage resources, such as local storage, network-attached storage (NAS), or cloud-based storage solutions.

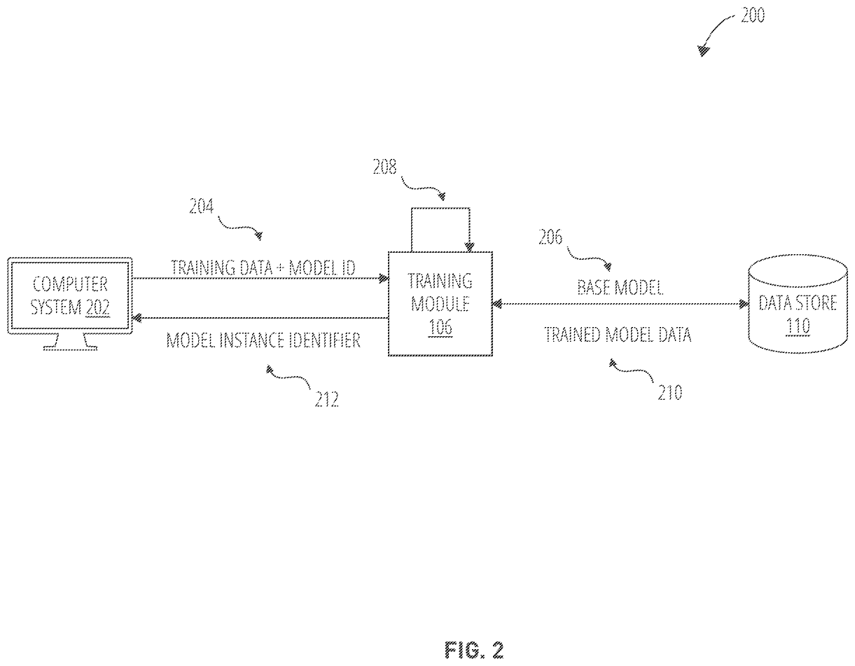

FIG. 2 illustrates an example flow performed with the training system 200 to train fine-tuned models. In some instances, the training system 200 is incorporated into the orchestration platform 100, as previously discussed. In other instances, the training system 200 is a standalone system or separate system that performs the training operations and provides the fine-tuned models, including the layers to the orchestration platform 100 to perform the inference operations.

In the illustrated example, the training module 106 receives requests to train a base model on a specific data set to generate one or more layers from a computer system 202 at 204. The computer system 202 is any type of computer system, including processing and memory resources. In some instances, the computer system 202 is operated by a customer of the orchestration platform 100. In other instances, the computer system 202 is operated by the operator of the orchestration platform 100.

The computer system 202 sends a request to the training module 106 to train one or more layers, such as a Low-Rank Adaptation (LoRA) layer. A LoRA layer is a type of layer used in neural networks for various tasks, e.g., text generation, question answering, summarization, etc. The training module 106 performs training operations such that the LoRA captures long-range dependencies in sequences, such as natural language sentences or time series data. The training module 106 uses optimization algorithms to adjust the LoRA layer's parameters and learn from input sequences during the training process. By doing so, the LoRA captures complex patterns and dependencies in training data.

In embodiments, the training module 106 receives the request, training data, and a model identifier. Training a fine-tuned model includes optimizing an existing pre-trained model, e.g., a base model, on a specific task or domain. In embodiments, the model identifier included with the requests identifies a base model in the data store 110. The training module 106 retrieves the base model from the data store 110 at 206. In embodiments, the base model is a model that is already trained on a similar task to the requested specific task using a general dataset, or a more general model. The training module 106 prepares the training data to train the base model. For example, the training module 106 formats the data for the model type. In one example, the training module 106 resizes and pre-processes images for an image classification model. In another example, the training module 106 tokenizes and pre-processes text for a natural language model.

At 208, the training module 106 trains the model with the training data set. Specifically, the training module 106 builds upon the knowledge and parameters learned from a pre-trained model and adapts them to a new, related task. As mentioned, the base model is typically trained on a large-scale, general dataset during a pre-training process. The training data for the request is a smaller, task-specific dataset relevant to a target or specific task. The training data may be labeled or unlabeled, depending on the available resources. The training module 106 updates the parameters of the pre-trained model using the task-specific dataset. The extent of fine-tuning can vary depending on factors such as the size of the dataset and the similarity of the task to the pre-training task. In some instances, the training module 106 freezes (keeps unchanged) the initial layers of the base model, and adjusts the parameters of one or more additional layers to adapt to a new task. This process allows the fine-tuned model to capture task-specific information and nuances, leveraging the knowledge learned from the pre-training stage. In embodiments, a model instance identifier identifies one or more layers generated during the fine-tuning process. The training module 106 generates the model instance identifier for the one or more layers and stores the one or more layers with the identifier in the data store 110 at 210. In some instances, the training module 106 stores data associated with the fine-tuning process with the one or more layers in metadata, e.g., version details, dataset details, base model details, etc. The training module 106 also returns the model instance identifier to the computer system 202 at 212. The customer may utilize the model instance identifier to request inference calculations with the specifically tailored layers identified by the model instance identifier.

In embodiments, the training module 106 trains a number of fine-tuned models with the same base model with different task-specific datasets. Each of the different fine-tuned models trained on one of the different task-specific datasets includes one or more layers that are unique to that specific fine-tuned model. The training module 106 identifies the base model with a model identifier. In one example, the training module 106 initiates the training process with the following instructions “train_obj=Trainer ( )” and “train_obj.load_context (model_id)”. Then for each incoming training request, the training module 106 invokes the “train_obj.train (training_configs)”, where the training_configs are provided in the request to perform the training. The training module 106 performs the fine-tuning process and stores data associated with the model and layers in the Data Store 110.

In one specific, the training module 106 utilizes a base model that is trained on a large data set of shoes to perform fine-tuning operations on different specific datasets, e.g., data sets of different brands or different types of shoes. Each time the training module 106 fine-tunes the base model trained on a large data of shoes one or different, new layers are generated. The training module 106 stores each of the newly generated layers in the data store 110 with its own unique model instance identifier. Thus, as will be discussed in more detail below, a virtual environment executing a base model can be injected with one or more layers associated with a specific task based on the associated model instance identifier. This approach eliminates the need for separate virtual environment initialization and dependency installation exclusively for one or more layer training, making the entire process more efficient and streamlined.

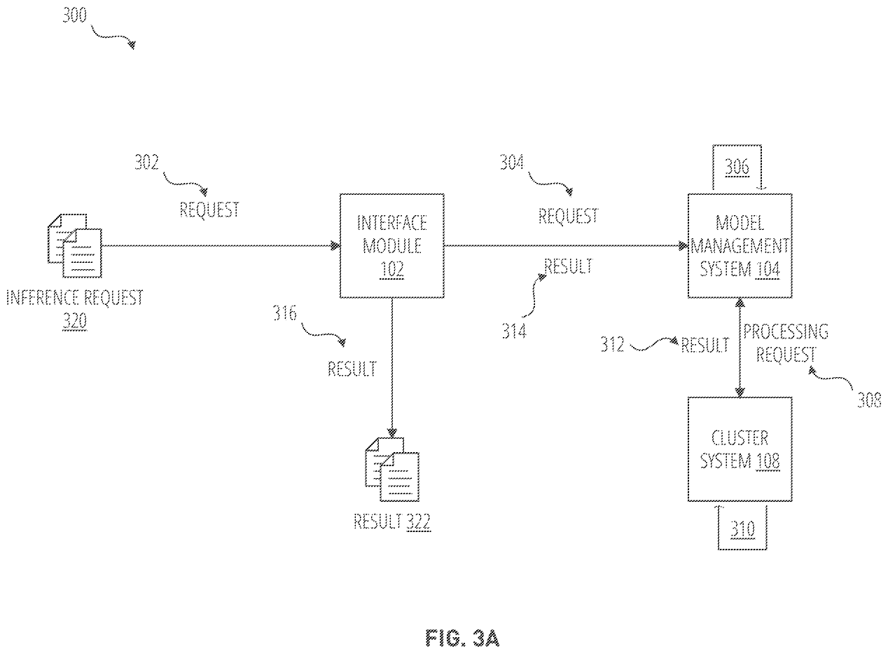

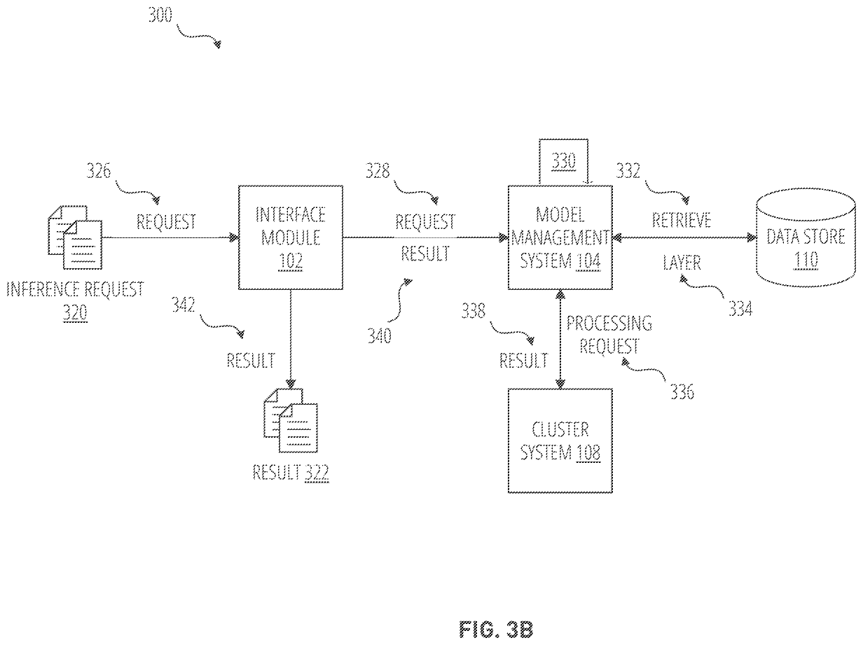

FIG. 3A illustrates an example flow performed by inference system 300 to process inference requests. In embodiments, the inference system 300 is part of the orchestration platform 100 and includes an interface module 102, a model management system 104, and a cluster system 108, as previously discussed.

In embodiments, the inference system 300 includes an interface module 102 to receive and process inference requests 320. In one example, the interface module 102 includes one or more application programming interfaces (APIs), such as a FastAPI layer. A FastAPI layer is a component or module built on top of the FastAPI framework to provide APIs with the Python® programming language. The FastAPI provides features, functionalities, or abstractions to the core framework. Specifically, the interface module 102, utilizing the FastAPI framework, provides authentication mechanisms, request/response validation, middleware, database integration, etc.

In embodiments, the interface module 102 provides one or more API endpoints and their associated operations for users to send requests and perform other operations. These operations can include HTTP methods such as GET, POST, PUT, DELETE, etc., and support path parameters, query parameters, and request bodies. The interface module 102 further automatically validates the incoming data against the defined types, preventing common runtime errors. The interface module 102 handles request and response serialization/deserialization, ensuring data integrity and enhancing development productivity. In addition, the interface module 102 supports WebSocket to provide real-time communication features.

In the illustrated example, the interface module 102 receives an inference request 320 via an API at 302. The inference requests include data, such as an inference payload to process with the model, a model identifier, and a model inference identifier. The model identifier identifies the base model, and the model inference identifier identifies one or more layers to use with the base model to perform the prediction. The model identifier and the model inference identifier can be included in the metadata of the inference request 320, but embodiments are not limited in this manner.

At 304, the interface module 102 sends the request to the model management system 104. At 306, the model management system 104 determines if an environment, including the base model and one or more layers, is executing on the cluster system 108. Specifically, the model management system 104 queries a database or other datastore with the model identifier and/or the model instance identifier to determine whether they are executing in the cluster system 108. In some instances, the check is performed by the interface module 102, and embodiments are not limited in this manner. In the illustrated flow, the model management system 104 determines an instance of the base model, and one or more layers are executing in an environment on the cluster system 108. As will be discussed in FIG. 3B, one or more of the base model and the one or more layers may not be operating in an environment on the cluster system 108, and the model management system 104 launches and/or inserts the one or more layers into an executing trained base model. In this example, the model management system 104 determines a base model with one or more layers are executing on the cluster system 108 and are ready to process the request. The model management system 104 schedules and sends the request to the cluster system 108 at 308. At 310, the cluster system 108 performs the inference operations for the request.

In embodiments, the cluster system 108 provides one or more virtual environments to execute fine-tuned models. Each of the virtual environments is allocated hardware resources to process data through fine-tuned models. In some instances, each of the virtual environments is specifically configured to process one or more trained base models based on specific requirements of the base model(s). For example, a virtual machine may be initiated on the cluster system 108 and one or more containers may further be invoked on the virtual machine. Each of the containers can execute a base model of the same type. Further, each of the base models may be inserted with the same or different layers to create different fine-tuned models. In addition, the cluster system 108 supports one or more instances of virtual environments. Thus, another virtual machine can be executed on the cluster system 108 configured to base model(s) of a different type and configured to accept one or more layers. Each of the fine-tuned models can process in parallel or serially and generate results. The results are based on the model and request made. For example, a fine-tuned model may perform text classification predictions, image classification predictions, summarization predictions, translation predictions, question-answering predictions, etc., based on the request, data provided in the request, and the model.

In some instances, the cluster system 108 performs a number of operations in the virtual environment to process the new data through the fine-tuned model. For example, in some instances, the cluster system 108 preprocesses the input data to make it compatible with the model's requirements. Specifically, the cluster system 108 may perform one or more of tokenization operations, normalization operations, encoding operations, or any other necessary transformations to convert the input into a format the model can understand. In other instances, the cluster system 108 receives the input data preprocessed.

Once the data is in the proper form for the model, the cluster system 108 encodes and transforms the preprocessed input data into a numerical representation suitable for the model's architecture. This ensures the model can process the input effectively. The cluster system 108 passes the encoded input through the fine-tuned model. This involves feeding the input through the model's layers, applying weights, biases, and activations, and performing computations to generate intermediate representations. Moreover, this includes processing the data through the one or more layers specifically trained on the data specific dataset. After the cluster system 108 performs the forward pass, the model generates predictions or generates a sequence based on the specific task it has been fine-tuned for. The output can take various forms, such as class predictions, probabilities, text sequences, or any other relevant output format. In some instances, the cluster system 108 post-processes the data depending on the task and output format. For example, the cluster system 108, in the virtual environment, decodes the numerical representation back into human-readable text, applying formatting additional steps to refine or present the final output. It is important to note that these steps may vary depending on the specific model architecture, task, and implementation. The fine-tuning process specifically involves adjusting the model's parameters to optimize its performance on a task, but the steps outlined above represent the process that a fine-tuned model follows during inference.

At 312, the cluster system 108 returns the results to the model management system 104. The inference results depend on the specific task the model has been fine-tuned. For example, if the model is fine-tuned for text classification, the inference results include predicting the class or category of a given text. The model outputs the most probable class label for the input text. If the model is fine-tuned for sequence generation, such as language translation or text summarization, the inference results involve generating a sequence of text that best represents the desired output. The model produces a translated version of the input text or a concise summary of a longer document. Further, the quality and accuracy of the inference results depend on the effectiveness of the fine-tuning process, the volume and diversity of the fine-tuning data, and the quality of the original pre-trained model. At 314 and 316, the model management system 104 sends the result 322 back to the customer system via the interface module 102 and APIs.

FIG. 3B illustrates another example flow performed by the inference system 300 to process inference requests. In some instances, a fine-tuned model including one or more layers to process a request is not executing in an environment on the cluster system 108. The illustrated flow in FIG. 3B includes the operations identifying one or more layers to launch in the cluster system 108 and launching the layers into a base model such that a fine-tuned model for the request is available.

At 326, the interface module 102 receives and processes an inference request 320 to perform an inference on the inference system 300, i.e., through an API framework. As mentioned, the inference request includes the inference payload to process by the model, a model identifier, and a model inference identifier. At 330, the interface module 102 sends the request to the model management system 104 to process. Note that in some instances, the interface module 102 may be one feature or component for the model management system 104 and not separate as shown.

At 330, the model management system 104 determines if an environment, including the base model and one or more layers, is executing on the cluster system 108 by querying a database or data store with the model identifier and/or model instance identifier. In some instances, the check is performed by the interface module 102. However, embodiments are not limited in this manner. In the illustrated flow, the model management system 104 determines an instance of the base model, including the one or more layers required for the request are not executing in a virtual environment on the cluster system 108.

In embodiments, the cluster system 108 operates one or more base models in virtual environments that are capable of receiving one or more layers specifically tailored for a request. The model management system 104 initiates these base models in separate containers with the same or different virtual environments. As previously discussed, each virtual machine is configured to provide one or more containers, and each of the containers on the same virtual machine is configured to execute a base model of the same type. Base models of a different type can execute in containers in a different virtual machine. In one example, the virtual environment is a virtual machine configured to execute a container operating on the containerization platform, such as Docker® and Kubernetes®. The model management system 104 and/or the cluster system 108 configures the container defined by specifications that specify the resources required by the model to execute in the container or environment. The resource specifications include CPU and memory allocations, network settings, and any specific environment variables or dependencies needed for the model processing. The model management system 104 provides these specifications during an initialization process of the container on the virtual machine from a database or data store.

In embodiments, the model management system 104 and cluster system 108 create a file that contains instructions to build the virtual environment image. In one example, the file is a Dockerfile (for Docker) or Deployment YAML (for Kubernetes). The model management system 104 and cluster system 108 install software packages for the environment, set up libraries, and copy the model files into the container and virtual environment. For example, if Kubernetes is utilized, the model management system 104 and cluster system 108 create a deployment YAML file that describes the container specification and any additional configurations like replicas, ports, and volumes to launch in a virtual machine.

In embodiments, the model management system 104 and cluster system 108 build an image using the file. For example, the model management system 104 and cluster system 108 build a Container Image Using a Dockerfile by executing a build command. The model management system 104 and cluster system 108 produce a container image that encapsulates a model, e.g., the base model, and its dependencies. In some instances, the model management system 104 and cluster system 108 insert the image into a registry so that it can be used in a virtual environment on the cluster system 108; examples of the container registry include Docker Hub or Google Container Registry. The model management system 104 and cluster system 108 can deploy the image in a virtual environment when needed.

As discussed, embodiments include having one or more of the base models deployed/executing in virtual environments to reduce the start-up time of a full finely tuned model. In embodiments, the model management system 104 and cluster system 108 initiate an image or container by executing a run command or deploying the container to a Kubernetes cluster, e.g., cluster system 108. The model management system 104 and cluster system 108 ensure that the environment is correctly initialized, e.g., the appropriate volume mounts, and network settings and resource allocations are corrected based on a comparison with the model's requirements.

In some instances, the model management system 104 and cluster system 108 test and validate that the environment is executing for the model. For example, the model management systems 104 and 108 verify that the containerized model processing works as expected by running test data and validating the results. Further, the model management system 104 and cluster system 108 ensure that the processing speed, resource utilization, and output accuracy are within the required or specified ranges. The model management system 104 and cluster system 108 also provide monitoring and management tools to track the performance of the containerized model processing. For example, model management system 104 and cluster system 108 calculate metrics like resource usage, response times, and error rates. In some instances, the model management system 104 and cluster system 108 utilize these metrics to optimize and scale the containerized environment, if necessary.

Once a base model is executing on the cluster system 108, one or more layers for processing the request are fetched from the data store 110 and loaded into the environment on the cluster system 108. Specifically, the model management system 104 determines one or more layers by performing a lookup in the data store 110 with the model instance identifier in the request at 332. The model management system 104 retrieves the layers at 334 and loads them into the corresponding environment at 336. The cluster system 108, including the fine-tuned model, executes on the data provided in the request and generates one or more predictions or inferences to return as results 322 at 338. The fine-tuned model may process the data as described above in FIG. 3A, e.g., through the layers of the fine-tuned model. At 340 and 342, the model management system 104 sends the results 322 back to the initiating system via the interface module 102.

In some instances, one or more base models are pre-loaded or executing in a respective environment on the cluster system 108 prior to a request being received by the inference system 300. Thus, the model management system 104 and cluster system 108 do not need to initiate the base model on the cluster system 108, as it is already running. In these instances, the model management system 104 retrieves one or more layers for a request and loads them into an already running base model to create a fine-tuned model for the specific request.

In some instances, the inference system 300, including the model management system 104, pre-loads layers into faster storage or memory to further reduce processing time and time to initiate a base model with one or more layers. For example, the model management system 104 loads one or more layers corresponding to one or more model instance identifiers into volatile memory, such as cache. In embodiments, inference system 300, including the cluster system 108, utilizes a hierarchical caching technique. For example, one or more layers are cached or shared on multiple levels, host-level caching, and cluster-level caching. The caching architecture will not only minimize the latency on fetching LoRA layers but also maximize the parallelism of inferences.

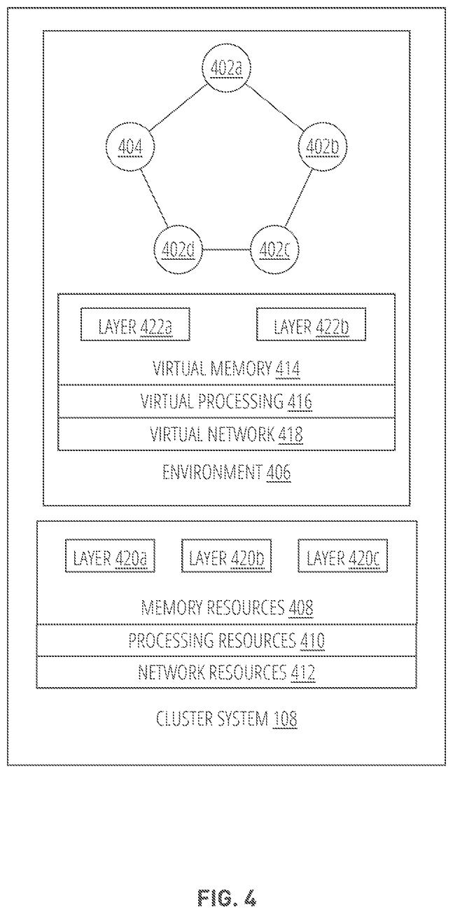

FIG. 4 illustrates an example configuration of a cluster system 108 in accordance with embodiments. The cluster system 108 includes software and hardware components to provide virtual environments for model processing. In the illustrated example, the cluster system 108 includes hardware components memory resources 408, processing resources 410, and network resources 412.

The memory resources 408 include both the physical hardware components, such as RAM (Random Access Memory), as well as storage systems, such as hard disk drives or solid-state drives, used for temporary or long-term data storage. These memory resources are crucial for the functioning of various computer systems, including the orchestration platform 100 and applications, as they enable quick access to data and efficient processing of information.

The processing resources 410 include various components and capabilities of a computer system that are responsible for executing tasks and operations. Examples include the central processing units (CPUs), which is the core component performing calculations and executing instructions, as well as graphics processing units (GPUs) that handle specialized processing tasks related to graphics and visual rendering. Processing resources also encompass other hardware components like dedicated application-specific integrated circuits (ASICs), field-programmable gate arrays (FPGAs), and digital signal processors (DSPs), which are designed for specific types of processing tasks. Additionally, processing resources can involve software components such as compilers, interpreters, and programming frameworks that facilitate the execution of code on the hardware. The combined power and efficiency of processing resources influence the speed, capacity, and overall performance of the orchestration platform 100 in performing computations, data processing, and executing software applications.

The network resources 412 includes various components and infrastructure that facilitate communication and data transfer between devices within a computer network, such as the cluster system 108 and other components of the inference system 300 and/or the orchestration platform 100. These resources include both physical and logical elements. Physical network resources include networking hardware such as routers, switches, hubs, network cables, wireless access points, and networking cards. These components enable the physical connectivity and transmission of data across the network. Logical network resources include protocols, standards, and software-defined network (SDN) configurations that govern the behavior and operation of the network. This includes protocols like TCP/IP (Transmission Control Protocol/Internet Protocol), Ethernet, Wi-Fi, and other networking protocols that establish rules for data transfer and enable devices to communicate with each other. Network resources also include bandwidth, which determines the capacity and speed at which data can be transferred across the network. Bandwidth can be shared among devices or allocated dedicatedly to specific devices or applications. Overall, network resources enable connectivity and data transfer between devices, ensuring effective communication and information exchange within a network infrastructure.

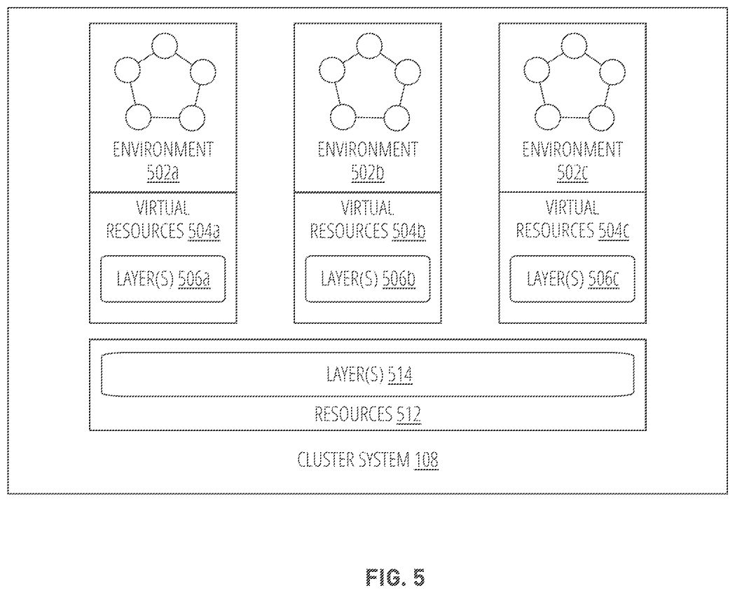

The cluster system 108, including the resources, enables one or more virtual environments to execute and provide modeling services. In embodiments, the cluster system 108 supports providing a number of environments 406, and each can be configured for one or more particular tasks. Moreover, each of the environments 406 can support processing of one or more base models 402a-402d, and fine-tuned model 404. The environment 406 includes virtual resources, such as virtual memory resources 414, virtual processing resources 416, and virtual network resources 418. In embodiments, environment 406 is a virtual machine initialized on the cluster system 108. The virtual machine further supports one or more containers, each of which can operate a base model or finely-tuned model once one or more layers are loaded into a base model. Further and as illustrated in FIG. 5 the cluster system 108 supports one more environment 406, each of which can execute one or more containers further supporting models. Each of the environments 406 can be tailored and configured for a specific base model type, e.g., a base model trained on a particular general dataset.

The virtual memory resources 414 is allocated memory resources within the environment 406. Memory allocations within environment 406 can be configured by parameters such as memory caps, memory limits, and memory reservation. Memory caps define the upper limit of memory usage for environment 406, while memory limits restrict the maximum amount of memory environment 406 can consume. Memory reservation reserves a minimum amount of memory for an environment 406, ensuring that it will have access to a certain baseline level of memory.

The virtual processing resources 416 include allocation and utilization of computational power within virtualized environments 406. These resources represent the virtualized and abstracted version of physical processing units available to virtualized systems. In virtualization, the concept of virtual processing resources allows multiple virtual instances to share the underlying physical processors of the cluster system 108. Virtualization software divides the physical processing capacity into virtual processing units and dynamically allocates these virtual resources to different environments 406 based on their respective workload demands.

The virtual network resources 418 are the virtualized components and capabilities within a computer network that are used to establish and manage network connectivity within a virtualized environment. The virtual network resources 418 include virtual network interfaces or virtual representations of network interface cards (NICs) that enable connectivity between virtual environments 406 and the broader network. In one example, each environment 406 can have one or more virtual network interfaces that handle the transmission and receipt of network data.

Each of the virtual environments 406 support executing one or more containers and one or more models to process data. In the illustrated example of FIG. 4, the environment 406 includes five models that executing. Specifically, the environment 406 includes four base models 402A-402D, and a fine-tuned model 404. Each of the base models 402a-402D are capable of receiving one or more additional layers and performing processing for an inference request. The fine-tuned model 404 is already configured with one or more layers and can perform modeling services for specific requests. base.

In embodiments, instances of one or more layers can be cached or pre-loaded into one of the memories of the cluster system 108. For example, one or more layers 420a-420c are pre-loaded into memory resources 408. Each instance of the one or more layers 420a-420c can be the same layers identified by the same model instance identifier. In other instances, one or more of layers 420a-420c are different and are identified by different model instance identifiers.

In additions to layers 420a-420c being pre-loaded into memory, one or more layers 422 can also be pre-loaded into virtual memory 414. Similarly, virtual memory 414 also includes one or more layers 422a and 422b. Each of these layers 422a and 422b can be the same layers and identified by the same model instance identifier or may be different and identified by different model instance identifiers.

In embodiments, the most utilized layers 422 are cached into the virtual memory 414 (e.g., host level cache) since they are loaded into a base model 402 the fastest. Other, often-used layers 420 are cached into memory resources 408. These layers 420 are also available to be quickly loaded into a base model 402. In some instances, layers are swapped between the memories 408 and 414, e.g., a layer 422 is moved down to memory 408 if it is being utilized less often or vice versa, a layer 420 is moved up to memory 414. Additionally, layers 422 and/or 420 can be moved back to a more permanent storage, such as data store 110.

FIG. 5 illustrates additional details a cluster system 108 in accordance with embodiments. FIG. 5 illustrates the cluster system 108, including a number of environments 502. Each of the environments 502 can be configured differently to support different base model types that operate in different container configurations. Thus, environment 502a can be configured differently than environment 502b and environment 502c, each of which can support different container configurations.

In embodiments, each of the environments 502 and virtual resources 504 can operate within the same container or different containers, and each of the containers can be configured differently to support the particular requirements for a base model, e.g., virtual resources 504 allocation and environment 502 configuration. For example, environment 502a, and virtual resources 504a can be configured to operate within one container, while environments 502b and 502c and virtual resources 504b and 504c can be configured to operate in a different container. Each container can be configured different to support the different needs of the base models that are to operate in them.

Further, the cluster system 108 can support a fast caching scheme in which one or more layers are preloaded into memory of one or more nodes of the cluster system 108 to be quickly loaded into a base model when requested. Specifically, FIG. 5 illustrates the cluster system 108 having layers pre-loaded into cache in both the virtual resources 504a-504c. In the illustrated example, the cluster system 108 includes number of active environments 502a-502c processing a number of models. Each of the environments 502A-502C are allocated virtual resources 504A-504C, e.g., virtual memory resources, virtual processing resources, and virtual network resources. These environments and virtual resources operate on the physical resources 512 of the cluster system 108.

Embodiments discussed herein include the model management system 104 loading or pre-loading one or more layers into one or more of the memory resources on the cluster system 108. In some instances, the model management system 104 and cluster system 108 loads one or more layers in the cache (e.g., host level cache) of a shared virtual resource in the one or more environments, e.g., the layers 506A-506C loaded into virtual resources 504A-504C. These layers 506A-506C can be loaded into one or more of the base models operating on the environments 502A-502C the fastest when inference requests are received, and the layers are needed for processing. Thus, in one example, the model management system 104 loads the most used layers into the virtual memory resources to quickly load into a base model to process an inference request.

In some instances, the model management system 104 and cluster system 108 load or pre-load layers into the cache of the resources 512 of the cluster system 108, e.g., the cluster level cache. Specifically, layer 514 is loaded into the resources 512 such that it can be quickly loaded into a base model on one or more of the environments 502A-502C. These layers 514 may be ones typically used across different environments and/or less frequently than the layers 506 in the virtual resources 504. Embodiments are not limited in this manner.

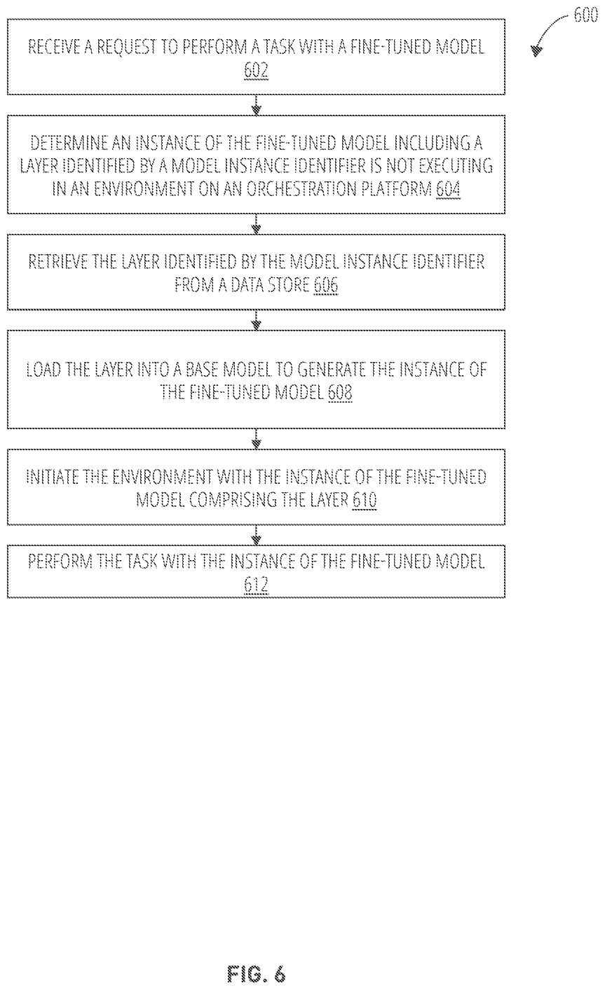

FIG. 6 illustrates an example routine 600 in accordance with embodiments.

In block 602, routine 600 includes receiving a request to perform a task with a fine-tuned model. In embodiments, the task is performing inference calculations and/or generating predictions with a fine-tuned model. The request also includes one or more identifiers, such as a model instance identifier and a model identifier. The request also includes a payload, e.g., data for a model to process on.

In block 604, the routine 600 includes determining an instance of the fine-tuned model including a layer identified by the model instance identifier is not executing in an environment on the orchestration platform. Specifically, the orchestration platform 100 polls a database or other data structure to identify that the layer associated with the model instance identifier is not executing on the cluster system.

In block 606, routine 600 includes retrieving the layer identified by the model instance identifier from a data store. Specifically, the orchestration platform 100 retrieves the layer with the model instance identifier from a storage, such as a Blob storage. In other instances, the layer may be preloaded into faster, non-volatile memory, such as cluster cache, or container cache. The layer is trained or pre-trained with a data set specific for the task.

In block 608, the routine 600 includes loading the layer into a base model to generate the instance of the fine-tuned model. In some instances, the base model is preloaded and executing in environment, such as a container, on the cluster system prior to the request being received by the system. For example, the orchestration platform 100 preloads the most frequently used base models into one or more environments that are allocated on the cluster system. Each of the base models are trained or pre-trained on a larger dataset, such as a large language dataset.

In block 610, the routine 600 includes initiating the environment with the instance of the fine-tuned model comprising the layer. Specifically, the orchestration platform 100 loads the layer into the base model to generate a fine-tuned model to process the request. In embodiments, the layer acts as an additional component that can be appended or inserted into the base model. In some instances, the environment is configured and is executing on a cluster system and is prepared to handle the layer and process inferences. Thus, the layer is quickly inserted into an executing base model, and in block 612, the routine 600 includes performing the task with the instance of the fine-tuned model.

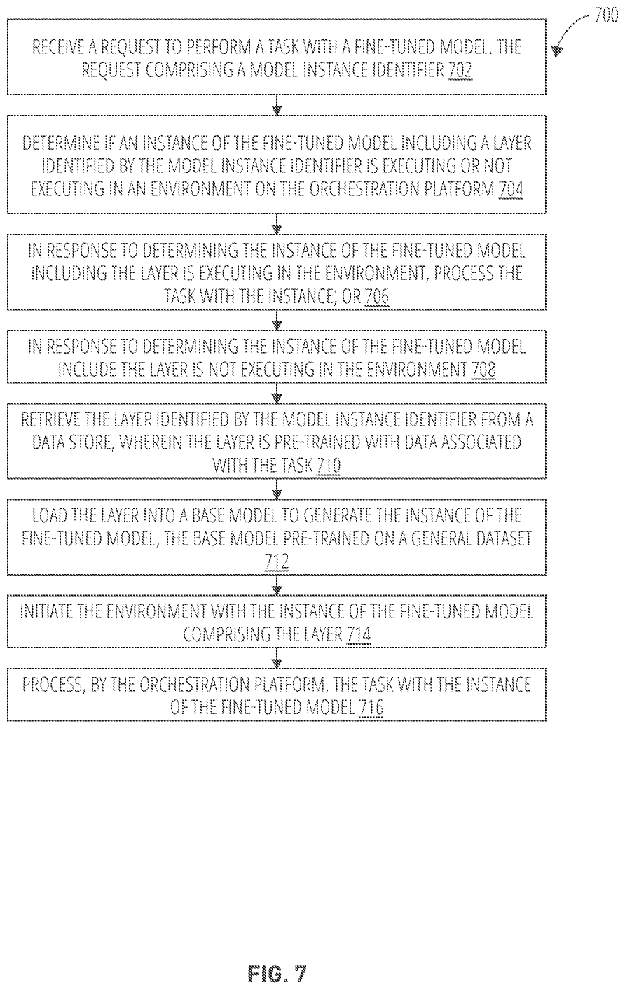

FIG. 7 illustrates an example routine 700 in accordance with embodiments. The following routine 700 can be performed by the orchestration platform 100 including one or more of the components thereof.

In block 702, routine 700 includes receiving a request to perform a task with a fine-tuned model, the request comprising a model instance identifier. In some instances, the request includes a payload to process by the model and a model identifier to identify a base model.

In block 704, routine 700 includes determining if an instance of the fine-tuned model including the layer identified by the model instance identifier is executing or not executing in an environment on the orchestration platform. In one example, the orchestration platform 100 performs a lookup in a database or other data structure listing all executing fine-tuned models to determine if the layer is executing in a base model.

In block 706, routine 700, in response to determining the instance of the fine-tuned model includes the layer is executing in the environment, processes the task with the instance. Specifically, the orchestration platform 100 sends the request, including data, to the fine-tuned model on a cluster system, and the cluster system processes the request through the model to determine one or more predictions or inferences for the request.

In block 708, routine 700 in response to determining the instance of the fine-tuned model including the layer identified by the model instance identifier is not executing in the environment, the routine 700 performs additional operations including, but not limited, those described in blocks 710-716.

In block 710, routine 700 includes retrieving the layer identified by the model instance identifier from a data store, wherein the layer is pre-trained with data associated with the task. In some instances, the layer is retrieved from a datastore, such as cloud-storage, or from cache, such as cluster cache or container cache.

In block 712, routine 700 includes loading the layer into a base model to generate the instance of the fine-tuned model, the base model is pre-trained on a general dataset and the layer is trained in the base model with a specific dataset. In some instances, the environment is executing and pre-loaded with the base model, and the layer is inserted into the model, and the environment performs the inference operations. At block 714, the fine-tuned model is executed on the cluster system. In block 716, routine 700 includes performing the task with the instance of the fine-tuned model, e.g., generating inference or prediction results.

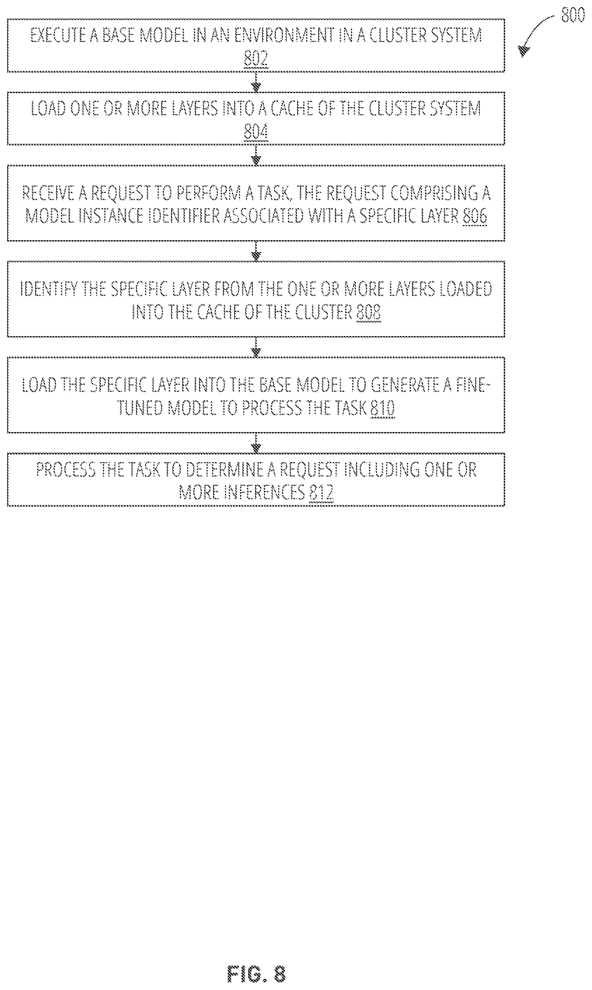

FIG. 8 illustrates an example routine 800 in accordance with embodiments. The following routine 800 can be performed by the orchestration platform 100 including one or more of the components thereof.

In block 802, routine 800 includes executing a base model in an environment in a cluster system. For example, the orchestration platform 100 may generate an environment based on requests to process models including the fine-tuned model and execute the environment such that it is operational and ready to receive additional layers and process data. In instances, the orchestration platform 100 initiates and executes a number of base models in one or more environments such that a number of models can loaded with one or more layers to perform inferences and generate results in parallel. The orchestration platform 100 may determine the base models to initiate based on a frequency of use or other criteria, e.g., slowest to initiate, user request, etc.

In block 804, the routine 800 includes loading one or more layers into a cache of the cluster system. The orchestration platform 100 can load the one or more layers into cluster cache, e.g., part of the cluster's memory resources that are not allocated to a specific environment. In other instances, the orchestration platform 100 loads the one or more layers into container cache, e.g., virtual memory resources that are allocated to a particular container or environment. Thus, orchestration platform 100 utilizes a two-layer cache configured to pre-load layers, as previously discussed. The orchestration platform 100 is only required to pull one or more layers from storage if there is a cache miss, e.g., one or more layers are not pre-loaded into either the cluster cache or container cache.

In block 806, routine 800 includes receiving a request to perform a task. The request comprises a model instance identifier associated with a specific layer. Further and at block 808, the routine 800 includes identifying the specific layer from the one or more layers loaded into the cache of the cluster. In some instances, if one or more layers are required to perform inference but are not pre-loaded from the cache, one or more layers are retrieved from storage, e.g., a Blob storage. In some instances, the orchestration platform 100 identifies the specific layer based on information stored in a database or other storage structure tracking models and layers pre-loaded onto a cluster system.

In block 810, routine 800 includes loading the specific layer into the base model to generate a fine-tuned model to process the task, and at block 812, the routine 800 includes processing the task to determine a request including one or more inferences.

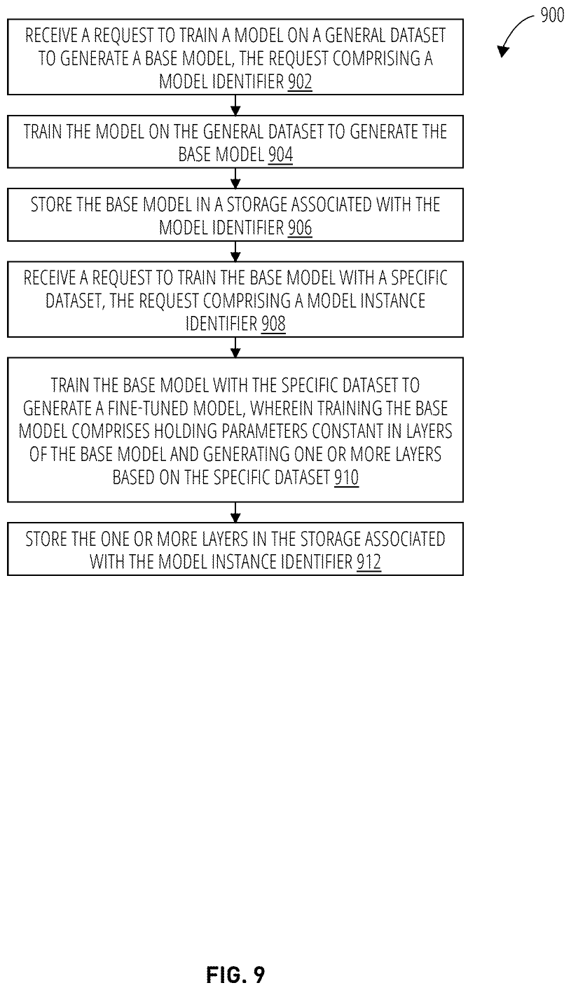

FIG. 9 illustrates an example routine 900 in accordance with embodiments. The following routine 900 can be performed by the orchestration platform 100 including one or more of the components thereof.

In block 902, the routine 900 includes receiving a request to train a model on a general dataset to generate a base model. In embodiments, the request is received with the general dataset or an identifier to identify the general dataset. The general dataset can be a large collection of data that encompasses a broad range of information. One example is a large language model dataset. In embodiments, the request also include a model identifier to identify a base model in storage.

In block 904, routine 900 includes training the model on the general dataset to generate the base model. Further and at block 906, the routine 900 includes storing the base model in a storage associated with the model identifier.

In block 908, the routine 900 includes receiving a request to train the base model with a specific dataset. The request includes a model instance identifier and the specific dataset or identifier to identify the specific dataset. The specific dataset is a collection of data that is narrowly focused on a particular subject.

In block 910, routine 900 includes training the base model with the specific dataset to generate a fine-tuned model, wherein training the base model comprises holding parameters constant in layers of the base model and generating or determining parameters for one or more layers based on the specific dataset. In block 912, routine 900 includes storing the one or more layers in the storage associated with the model instance identifier.

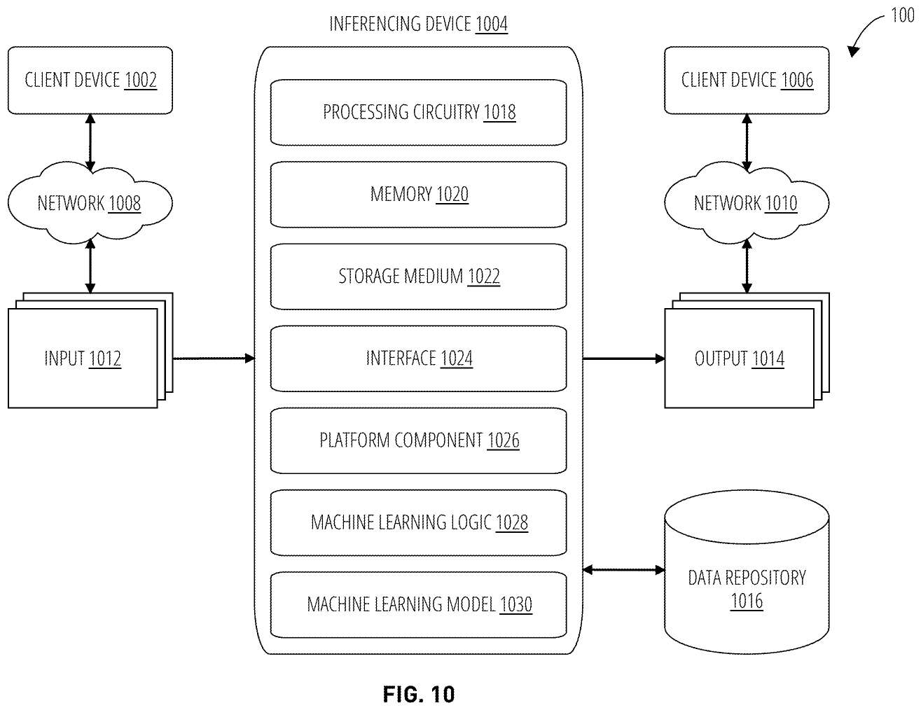

FIG. 10 illustrates an embodiment of a system 1000. The system 1000 is suitable for implementing one or more embodiments as described herein. In one embodiment, for example, the system 1000 is an AI/ML system suitable for operation on the orchestration platform 100.

The system 1000 comprises a set of M devices, where M is any positive integer. FIG. 10 depicts three devices (M=3), including a client device 1002, an inferencing device 1004, and a client device 1006. The inferencing device 1004 communicates information with the client device 1002 and the client device 1006 over a network 1008 and a network 1010, respectively. The information may include input 1012 from the client device 1002 and output 1014 to the client device 1006, or vice-versa. In one alternative, the input 1012 and the output 1014 are communicated between the same client device 1002 or client device 1006. In another alternative, the input 1012 and the output 1014 are stored in a data repository 1016. In yet another alternative, the input 1012 and the output 1014 are communicated via a platform component 1026 of the inferencing device 1004, such as an input/output (I/O) device (e.g., a touchscreen, a microphone, a speaker, etc.).

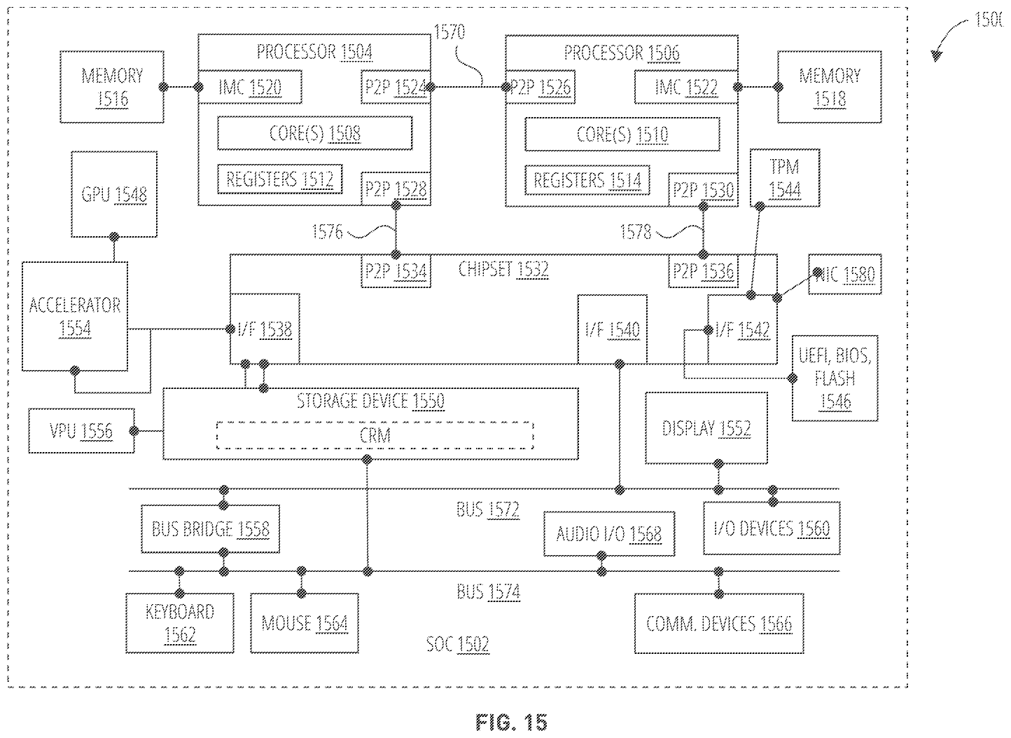

As depicted in FIG. 10, the inferencing device 1004 includes processing circuitry 1018, a memory 1020, a storage medium 1022, an interface 1024, a platform component 1026, ML logic 1028, and an ML model 1030. In some implementations, the inferencing device 1004 includes other components or devices as well. Examples for software elements and hardware elements of the inferencing device 1004 are described in more detail with reference to a computing architecture 1500 as depicted in FIG. 15. Embodiments are not limited to these examples.

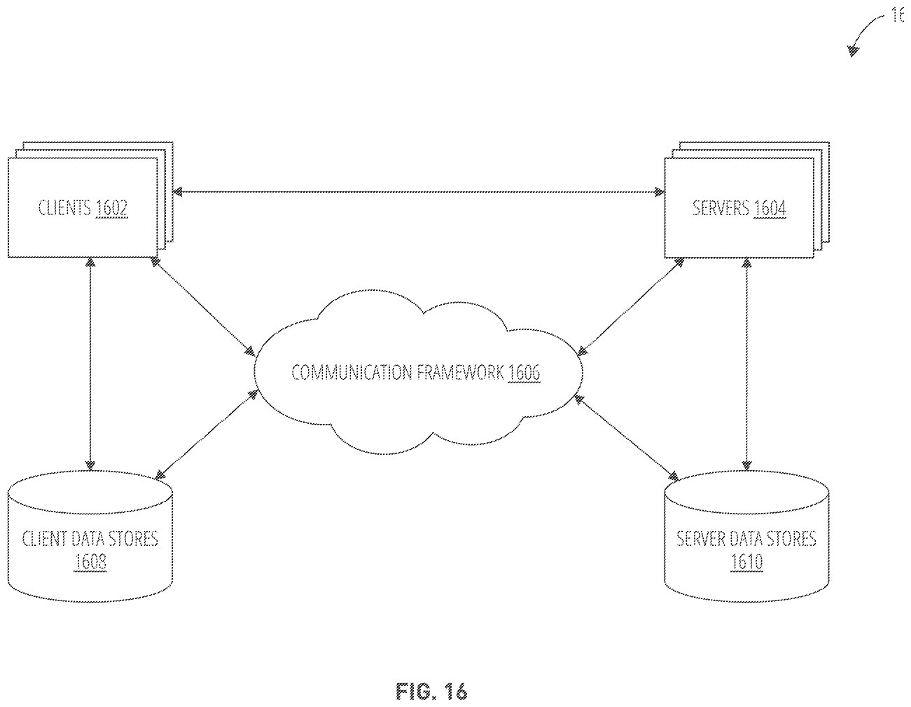

The inferencing device 1004 is generally arranged to receive an input 1012, process the input 1012 via one or more AI/ML techniques, and send an output 1014. The inferencing device 1004 receives the input 1012 from the client device 1002 via the network 1008, the client device 1006 via the network 1010, the platform component 1026 (e.g., a touchscreen as a text command or microphone as a voice command), the memory 1020, the storage medium 1022 or the data repository 1016. The inferencing device 1004 sends the output 1014 to the client device 1002 via the network 1008, the client device 1006 via the network 1010, the platform component 1026 (e.g., a touchscreen to present text, graphic or video information or speaker to reproduce audio information), the memory 1020, the storage medium 1022 or the data repository 1016. Examples for the software elements and hardware elements of the network 1008 and the network 1010 are described in more detail with reference to a communications architecture 1600 as depicted in FIG. 16. Embodiments are not limited to these examples.

The inferencing device 1004 includes ML logic 1028 and an ML model 1030 to implement various AI/ML techniques for various AI/ML tasks. The ML logic 1028 receives the input 1012, and processes the input 1012 using the ML model 1030. The ML model 1030 performs inferencing operations to generate an inference for a specific task from the input 1012. In some cases, the inference is part of the output 1014. The output 1014 is used by the client device 1002, the inferencing device 1004, or the client device 1006 to perform subsequent actions in response to the output 1014.

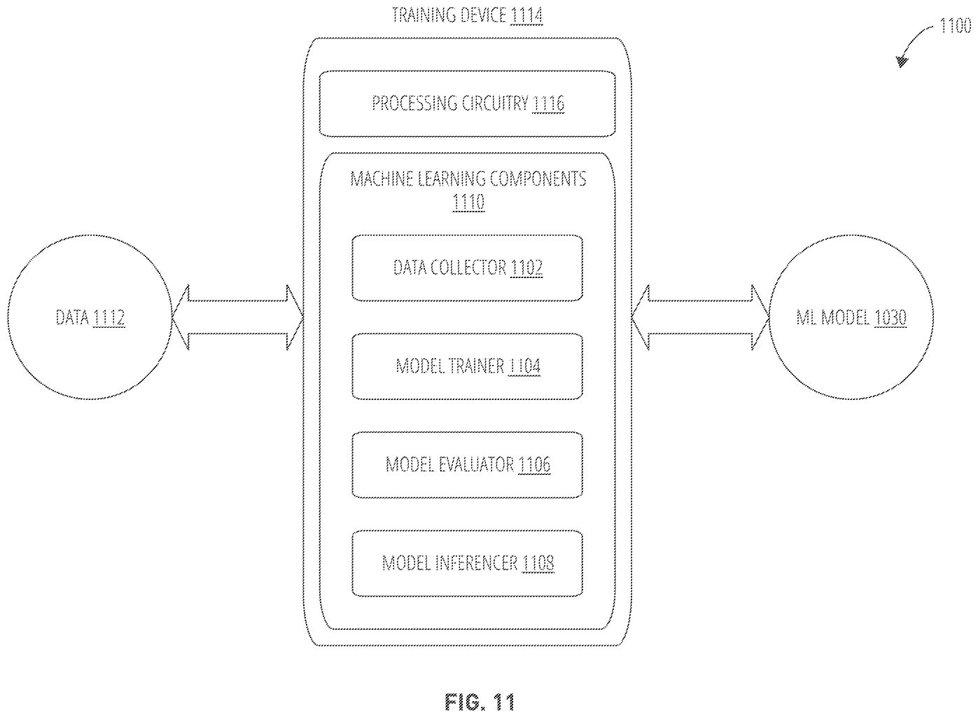

In various embodiments, the ML model 1030 is a trained ML model 1030 using a set of training operations. An example of training operations to train the ML model 1030 is described with reference to FIG. 11.

FIG. 11 illustrates an apparatus 1100. The apparatus 1100 depicts a training device 1114 suitable to generate a trained ML model 1030 for the inferencing device 1004 of the system 1000. As depicted in FIG. 11, the training device 1114 includes a processing circuitry 1116 and a set of ML components 1110 to support various AI/ML techniques, such as a data collector 1102, a model trainer 1104, a model evaluator 1106 and a model inferencer 1108.

In general, the data collector 1102 collects data 1112 from one or more data sources to use as training data for the ML model 1030. The data collector 1102 collects different types of data 1112, such as text information, audio information, image information, video information, graphic information, and so forth. The model trainer 1104 receives as input the collected data and uses a portion of the collected data as test data for an AI/ML algorithm to train the ML model 1030. The model evaluator 1106 evaluates and improves the trained ML model 1030 using a portion of the collected data as test data to test the ML model 1030. The model evaluator 1106 also uses feedback information from the deployed ML model 1030. The model inferencer 1108 implements the trained ML model 1030 to receive as input new unseen data, generate one or more inferences on the new data, and output a result such as an alert, a recommendation or other post-solution activity.

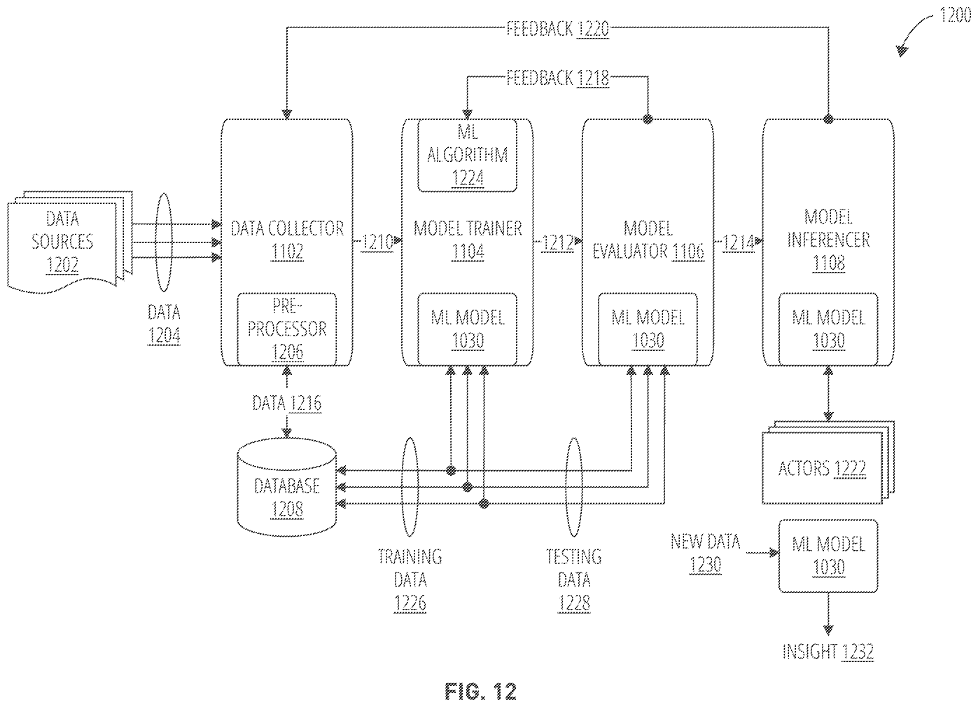

An exemplary AI/ML architecture for the ML components 1110 is described in more detail with reference to FIG. 12.

FIG. 12 illustrates an artificial intelligence architecture 1200 suitable for use by the training device 1114 to generate the ML model 1030 for deployment by the inferencing device 1004. The artificial intelligence architecture 1200 is an example of a system suitable for implementing various AI techniques and/or ML techniques to perform various inferencing tasks on behalf of the various devices of the system 1000.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1200 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1030, evaluate performance of the trained ML model 1030, and deploy the tested ML model 1030 as the trained ML model 1030 in a production environment, and continuously monitor and maintain it.

The ML model 1030 is a mathematical construct used to predict outcomes based on a set of input data. The ML model 1030 is trained using large volumes of training data 1226, and it can recognize patterns and trends in the training data 1226 to make accurate predictions. The ML model 1030 is derived from an ML algorithm 1224 (e.g., a neural network, decision tree, support vector machine, etc.). A data set is fed into the ML algorithm 1224 which trains an ML model 1030 to “learn” a function that produces mappings between a set of inputs and a set of outputs with a reasonably high accuracy. Given a sufficiently large enough set of inputs and outputs, the ML algorithm 1224 finds the function for a given task. This function may even be able to produce the correct output for input that it has not seen during training. A data scientist prepares the mappings, selects and tunes the ML algorithm 1224, and evaluates the resulting model performance. Once the ML logic 1028 is sufficiently accurate on test data, it can be deployed for production use.

The ML algorithm 1224 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1224 of the artificial intelligence architecture 1200 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 12, the artificial intelligence architecture 1200 includes a set of data sources 1202 to source data 1204 for the artificial intelligence architecture 1200. Data sources 1202 may comprise any device capable generating, processing, storing or managing data 1204 suitable for a ML system. Examples of data sources 1202 include without limitation databases, web scraping, sensors and Internet of Things (IoT) devices, image and video cameras, audio devices, text generators, publicly available databases, private databases, and many other data sources 1202. The data sources 1202 may be remote from the artificial intelligence architecture 1200 and accessed via a network, local to the artificial intelligence architecture 1200 an accessed via a network interface, or may be a combination of local and remote data sources 1202.

The data sources 1202 source difference types of data 1204. By way of example and not limitation, the data 1204 includes structured data from relational databases, such as customer profiles, transaction histories, or product inventories. The data 1204 includes unstructured data from websites such as customer reviews, news articles, social media posts, or product specifications. The data 1204 includes data from temperature sensors, motion detectors, and smart home appliances. The data 1204 includes image data from medical images, security footage, or satellite images. The data 1204 includes audio data from speech recognition, music recognition, or call centers. The data 1204 includes text data from emails, chat logs, customer feedback, news articles or social media posts. The data 1204 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1204 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1202 are communicatively coupled to a data collector 1102. The data collector 1102 gathers relevant data 1204 from the data sources 1202. Once collected, the data collector 1102 may use a pre-processor 1206 to make the data 1204 suitable for analysis. This involves data cleaning, transformation, and feature engineering. Data preprocessing is a critical step in ML as it directly impacts the accuracy and effectiveness of the ML model 1030. The pre-processor 1206 receives the data 1204 as input, processes the data 1204, and outputs pre-processed data 1216 for storage in a database 1208. Examples for the database 1208 includes a hard drive, solid state storage, and/or random access memory (RAM).

The data collector 1102 is communicatively coupled to a model trainer 1104. The model trainer 1104 performs AI/ML model training, validation, and testing which may generate model performance metrics as part of the model testing procedure. The model trainer 1104 receives the pre-processed data 1216 as input 1210 or via the database 1208. The model trainer 1104 implements a suitable ML algorithm 1224 to train an ML model 1030 on a set of training data 1226 from the pre-processed data 1216. The training process involves feeding the pre-processed data 1216 into the ML algorithm 1224 to produce or optimize an ML model 1030. The training process adjusts its parameters until it achieves an initial level of satisfactory performance.

The model trainer 1104 is communicatively coupled to a model evaluator 1106. After an ML model 1030 is trained, the ML model 1030 needs to be evaluated to assess its performance. This is done using various metrics such as accuracy, precision, recall, and F1 score. The model trainer 1104 outputs the ML model 1030, which is received as input 1210 or from the database 1208. The model evaluator 1106 receives the ML model 1030 as input 1212, and it initiates an evaluation process to measure performance of the ML model 1030. The evaluation process includes providing feedback 1218 to the model trainer 1104. The model trainer 1104 re-trains the ML model 1030 to improve performance in an iterative manner.

The model evaluator 1106 is communicatively coupled to a model inferencer 1108. The model inferencer 1108 provides AI/ML model inference output (e.g., inferences, predictions or decisions). Once the ML model 1030 is trained and evaluated, it is deployed in a production environment where it is used to make predictions on new data. The model inferencer 1108 receives the evaluated ML model 1030 as input 1214. The model inferencer 1108 uses the evaluated ML model 1030 to produce insights or predictions on real data, which is deployed as a final production ML model 1030. The inference output of the ML model 1030 is use case specific. The model inferencer 1108 also performs model monitoring and maintenance, which involves continuously monitoring performance of the ML model 1030 in the production environment and making any necessary updates or modifications to maintain its accuracy and effectiveness. The model inferencer 1108 provides feedback 1218 to the data collector 1102 to train or re-train the ML model 1030. The feedback 1218 includes model performance feedback information, which is used for monitoring and improving performance of the ML model 1030.

Some or all of the model inferencer 1108 is implemented by various actors 1222 in the artificial intelligence architecture 1200, including the ML model 1030 of the inferencing device 1004, for example. The actors 1222 use the deployed ML model 1030 on new data to make inferences or predictions for a given task, and output an insight 1232. The actors 1222 implement the model inferencer 1108 locally, or remotely receives outputs from the model inferencer 1108 in a distributed computing manner. The actors 1222 trigger actions directed to other entities or to itself. The actors 1222 provide feedback 1220 to the data collector 1102 via the model inferencer 1108. The feedback 1220 comprise data needed to derive training data, inference data or to monitor the performance of the ML model 1030 and its impact to the network through updating of key performance indicators (KPIs) and performance counters.

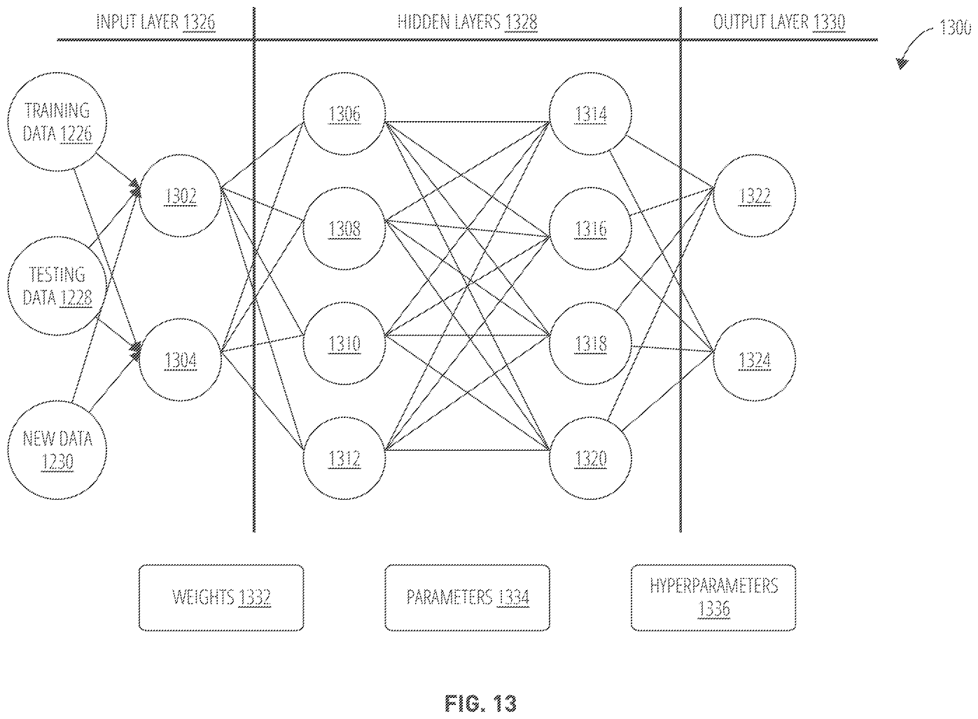

As previously described with reference to FIGS. 1, 2, the systems 1000, 1100 implement some or all of the artificial intelligence architecture 1200 to support various use cases and solutions for various AI/ML tasks. In various embodiments, the training device 1114 of the apparatus 1100 uses the artificial intelligence architecture 1200 to generate and train the ML model 1030 for use by the inferencing device 1004 for the system 1000. In one embodiment, for example, the training device 1114 may train the ML model 1030 as a neural network, as described in more detail with reference to FIG. 13. Other use cases and solutions for AI/ML are possible as well, and embodiments are not limited in this context.

FIG. 13 illustrates an embodiment of an artificial neural network 1300. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1300 comprises multiple node layers, containing an input layer 1326, one or more hidden layers 1328, and an output layer 1330. Each layer comprises one or more nodes, such as nodes 1302 to 1324. As depicted in FIG. 13, for example, the input layer 1326 has nodes 1302, 1304. The artificial neural network 1300 has two hidden layers 1328, with a first hidden layer having nodes 1306, 1308, 1310 and 1312, and a second hidden layer having nodes 1314, 1316, 1318 and 1320. The artificial neural network 1300 has an output layer 1330 with nodes 1322, 1324. Each node 1302 to 1324 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1300 relies on training data 1226 to learn and improve accuracy over time. However, once the the artificial neural network 1300 is fine-tuned for accuracy, and tested on testing data 1228, the artificial neural network 1300 is ready to classify and cluster new data 1230 at a high velocity. Tasks in speech recognition or image recognition can take minutes versus hours when compared to the manual identification by human experts.

Each individual node 1302 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b > \text{=} 0 ; 0 if \sum w 1 x 1 + b < 0$$

Once an input layer 1326 is determined, a set of weights 1332 are assigned. The weights 1332 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1300 as a feedforward network.

In one embodiment, the artificial neural network 1300 leverages sigmoid neurons, which are distinguished by having values between 0 and 1. Since the artificial neural network 1300 behaves similarly to a decision tree, cascading data from one node to another, having x values between 0 and 1 will reduce the impact of any given change of a single variable on the output of any given node, and subsequently, the output of the artificial neural network 1300.

The artificial neural network 1300 has many practical use cases, like image recognition, speech recognition, text recognition or classification. The artificial neural network 1300 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1334 of the model adjust to gradually converge at the minimum.

In one embodiment, the artificial neural network 1300 is feedforward, meaning it flows in one direction only, from input to output. In one embodiment, the artificial neural network 1300 uses backpropagation. Backpropagation is when the artificial neural network 1300 moves in the opposite direction from output to input. Backpropagation allows calculation and attribution of errors associated with each neuron 1302 to 1324, thereby allowing adjustment to fit the parameters 1334 of the ML model 1030 appropriately.

The artificial neural network 1300 is implemented as different neural networks depending on a given task. Neural networks are classified into different types, which are used for different purposes. In one embodiment, the artificial neural network 1300 is implemented as a feedforward neural network, or multi-layer perceptrons (MLPs), comprised of an input layer 1326, hidden layers 1328, and an output layer 1330. While these neural networks are also commonly referred to as MLPs, they are actually comprised of sigmoid neurons, not perceptrons, as most real-world problems are nonlinear. Trained data 1204 usually is fed into these models to train them, and they are the foundation for computer vision, natural language processing, and other neural networks. In one embodiment, the artificial neural network 1300 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1300 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1300 is implemented as any type of neural network suitable for a given operational task of system 1000, and the MLP, CNN, and RNN are merely a few examples. Embodiments are not limited in this context.

The artificial neural network 1300 includes a set of associated parameters 1334. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1300 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1336. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

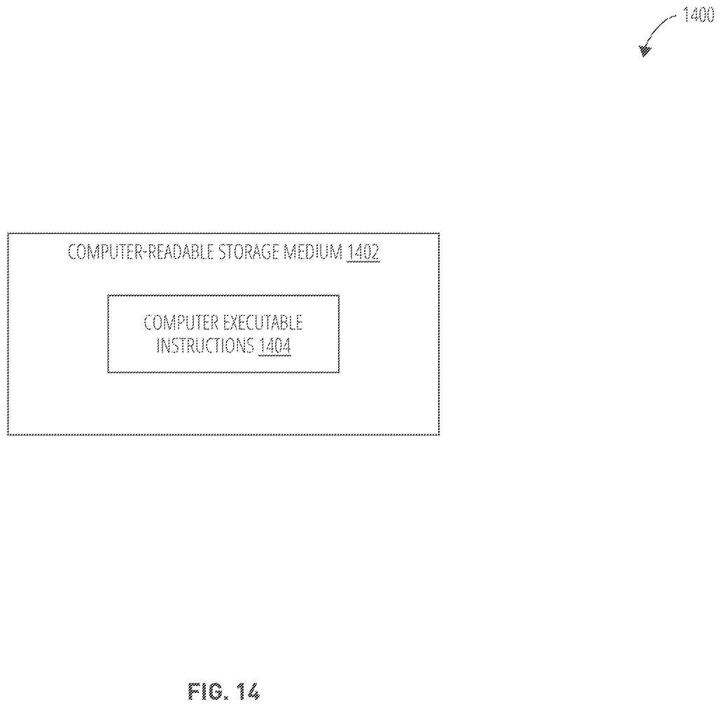

FIG. 14 illustrates an apparatus 1400. Apparatus 1400 comprises any non-transitory computer-readable storage medium 1402 or machine-readable storage medium, such as an optical, magnetic or semiconductor storage medium. In various embodiments, apparatus 1400 comprises an article of manufacture or a product. In some embodiments, the computer-readable storage medium 1402 stores computer executable instructions with which one or more processing devices or processing circuitry can execute. For example, computer executable instructions 1404 includes instructions to implement operations described with respect to any logic flows described herein. Examples of computer-readable storage medium 1402 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1404 include any suitable type of code, such as source code, compiled code, interpreted code, executable code, static code, dynamic code, object-oriented code, visual code, and the like.

FIG. 15 illustrates an embodiment of a computing architecture 1500. Computing architecture 1500 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1500 has a single processor with one core or more than one processor. Note that the term “processor” refers to a processor with a single core or a processor package with multiple processor cores. In at least one embodiment, the computing computing architecture 1500 is representative of the components of the system 1000. More generally, the computing computing architecture 1500 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1500. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 15, computing architecture 1500 comprises a system-on-chip (SoC) 1502 for mounting platform components. System-on-chip (SoC) 1502 is a point-to-point (P2P) interconnect platform that includes a first processor 1504 and a second processor 1506 coupled via a point-to-point interconnect 1570 such as an Ultra Path Interconnect (UPI). In other embodiments, the computing architecture 1500 is another bus architecture, such as a multi-drop bus. Furthermore, each of processor 1504 and processor 1506 are processor packages with multiple processor cores including core(s) 1508 and core(s) 1510, respectively. While the computing architecture 1500 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1504 and chipset 1532. Some platforms include additional components and some platforms include sockets to mount the processors and/or the chipset. Furthermore, some platforms do not have sockets (e.g. SoC, or the like). Although depicted as a SoC 1502, one or more of the components of the SoC 1502 are included in a single die package, a multi-chip module (MCM), a multi-die package, a chiplet, a bridge, and/or an interposer. Therefore, embodiments are not limited to a SoC.

The processor 1504 and processor 1506 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1504 and/or processor 1506. Additionally, the processor 1504 need not be identical to processor 1506.

Processor 1504 includes an integrated memory controller (IMC) 1520 and point-to-point (P2P) interface 1524 and P2P interface 1528. Similarly, the processor 1506 includes an IMC 1522 as well as P2P interface 1526 and P2P interface 1530. IMC 1520 and IMC 1522 couple the processor 1504 and processor 1506, respectively, to respective memories (e.g., memory 1516 and memory 1518). Memory 1516 and memory 1518 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1516 and the memory 1518 locally attach to the respective processors (i.e., processor 1504 and processor 1506). In other embodiments, the main memory couple with the processors via a bus and shared memory hub. Processor 1504 includes registers 1512 and processor 1506 includes registers 1514.

Computing architecture 1500 includes chipset 1532 coupled to processor 1504 and processor 1506. Furthermore, chipset 1532 are coupled to storage device 1550, for example, via an interface (I/F) 1538. The I/F 1538 may be, for example, a Peripheral Component Interconnect-enhanced (PCIe) interface, a Compute Express Link® (CXL) interface, or a Universal Chiplet Interconnect Express (UCIe) interface. Storage device 1550 stores instructions executable by circuitry of computing architecture 1500 (e.g., processor 1504, processor 1506, GPU 1548, accelerator 1554, vision processing unit 1556, or the like). For example, storage device 1550 can store instructions for the client device 1002, the client device 1006, the inferencing device 1004, the training device 1114, or the like.

Processor 1504 couples to the chipset 1532 via P2P interface 1528 and P2P 1534 while processor 1506 couples to the chipset 1532 via P2P interface 1530 and P2P 1536. Direct media interface (DMI) 1576 and DMI 1578 couple the P2P interface 1528 and the P2P 1534 and the P2P interface 1530 and P2P 1536, respectively. DMI 1576 and DMI 1578 is a high-speed interconnect that facilitates, e.g., eight Giga Transfers per second (GT/s) such as DMI 3.0. In other embodiments, the processor 1504 and processor 1506 interconnect via a bus.

The chipset 1532 comprises a controller hub such as a platform controller hub (PCH). The chipset 1532 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1532 comprises more than one controller hub such as a chipset with a memory controller hub, a graphics controller hub, and an input/output (I/O) controller hub.

In the depicted example, chipset 1532 couples with a trusted platform module (TPM) 1544 and UEFI, BIOS, FLASH circuitry 1546 via I/F 1542. The TPM 1544 is a dedicated microcontroller designed to secure hardware by integrating cryptographic keys into devices. The UEFI, BIOS, FLASH circuitry 1546 may provide pre-boot code. The I/F 1542 may also be coupled to a network interface circuit (NIC) 1580 for connections off-chip.

Furthermore, chipset 1532 includes the I/F 1538 to couple chipset 1532 with a high-performance graphics engine, such as, graphics processing circuitry or a graphics processing unit (GPU) 1548. In other embodiments, the computing architecture 1500 includes a flexible display interface (FDI) (not shown) between the processor 1504 and/or the processor 1506 and the chipset 1532. The FDI interconnects a graphics processor core in one or more of processor 1504 and/or processor 1506 with the chipset 1532.

The computing architecture 1500 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1554 and/or vision processing unit 1556 are coupled to chipset 1532 via I/F 1538. The accelerator 1554 is representative of any type of accelerator device (e.g., a data streaming accelerator, cryptographic accelerator, cryptographic co-processor, an offload engine, etc.). One example of an accelerator 1554 is the Intel@Data Streaming Accelerator (DSA). The accelerator 1554 is a device including circuitry to accelerate copy operations, data encryption, hash value computation, data comparison operations (including comparison of data in memory 1516 and/or memory 1518), and/or data compression. Examples for the accelerator 1554 include a USB device, PCI device, PCIe device, CXL device, UCIe device, and/or an SPI device. The accelerator 1554 also includes circuitry arranged to execute machine learning (ML) related operations (e.g., training, inference, etc.) for ML models. Generally, the accelerator 1554 is specially designed to perform computationally intensive operations, such as hash value computations, comparison operations, cryptographic operations, and/or compression operations, in a manner that is more efficient than when performed by the processor 1504 or processor 1506. Because the load of the computing architecture 1500 includes hash value computations, comparison operations, cryptographic operations, and/or compression operations, the accelerator 1554 greatly increases performance of the computing architecture 1500 for these operations.

The accelerator 1554 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1554. For example, the accelerator 1554 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1554 via a non-posted write (e.g., a deferred memory write (DMWr)). One example of an instruction that atomically submits a work descriptor to the shared work queue of the accelerator 1554 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1554. The dedicated work queue may accept job submissions via commands such as the movdir64b instruction.

Various I/O devices 1560 and display 1552 couple to the bus 1572, along with a bus bridge 1558 which couples the bus 1572 to a second bus 1574 and an I/F 1540 that connects the bus 1572 with the chipset 1532. In one embodiment, the second bus 1574 is a low pin count (LPC) bus. Various input/output (I/O) devices couple to the second bus 1574 including, for example, a keyboard 1562, a mouse 1564 and communication devices 1566.

Furthermore, an audio I/O 1568 couples to second bus 1574. Many of the I/O devices 1560 and communication devices 1566 reside on the system-on-chip (SoC) 1502 while the keyboard 1562 and the mouse 1564 are add-on peripherals. In other embodiments, some or all the I/O devices 1560 and communication devices 1566 are add-on peripherals and do not reside on the system-on-chip (SoC) 1502.

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 includes one or more clients 1602 and servers 1604. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 communicate information between each other using a communication framework 1606. The communication framework 1606 implements any well-known communications techniques and protocols. The communication framework 1606 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1606 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1000/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1602 and the servers 1604. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A computer-implemented method, comprising:
receiving, by an orchestration platform, a request to perform a task with a fine-tuned model, the request comprising a model instance identifier;
determining, by the orchestration platform, an instance of the fine-tuned model including a layer identified by the model instance identifier is not executing in an environment on the orchestration platform;
retrieving, by the orchestration platform, the layer identified by the model instance identifier from a data store, wherein the layer is pre-trained with data associated with the task;
loading, by the orchestration platform, the layer into a base model to generate the instance of the fine-tuned model, the base model pre-trained on a general dataset;
initiating, by the orchestration platform, the environment with the instance of the fine-tuned model comprising the layer; and
performing, by the orchestration platform, the task with the instance of the fine-tuned model.

2. The computer-implemented method of claim 1, comprising returning, by the orchestration platform, a result to performing the task.

3. The computer-implemented method of claim 1, comprising pre-training the layer with the base model.

4. The computer-implemented method of claim 1, comprising storing, by the orchestration platform, a plurality of layers including the layer in the data store, wherein each of the plurality of layers is identified with a different model instance identifier.

5. The computer-implemented method of claim 4, wherein each of the plurality of layers is pre-trained with one of a plurality of base models.

6. The computer-implemented method of claim 1, comprising identifying, by the orchestration platform, the base model with a model identifier.

7. The computer-implemented method of claim 6, wherein the request comprises a payload and metadata, and the metadata further comprises the model identifier and the model instance identifier.

8. The computer-implemented method of claim 7, wherein the payload comprises data, and the performing the task comprises determining an inference by processing the data with the fine-tuned model.

9. The computer-implemented method of claim 6, comprising pre-training a plurality of base models including the base model with a different general dataset.

10. The computer-implemented method of claim 1, comprising storing, by the orchestration platform, a plurality of base models in the data store, wherein each of the plurality of base models is identified with a different model identifier.

11. The computer-implemented method of claim 1, comprising executing, by the orchestration platform, one or more of the plurality of base models in preparation to receive a plurality of layers.

12. The computer-implemented method of claim 1, wherein the environment comprises a container comprising data and executing one or more processes to execute the fine-tuned model and the layer.

13. The computer-implemented method of claim 12, wherein the environment is configured to execute a plurality of fine-tuned models with layers.

14. A non-transitory computer-readable storage medium, the computer-readable storage medium including instructions that when executed by a processor, cause the processor to:
receiving a request to perform a task with a fine-tuned model, the request comprising a model instance identifier;
determining if an instance of the fine-tuned model including a layer identified by the model instance identifier is executing or not executing in an environment on an orchestration platform;
in response to determining the instance of the fine-tuned model include the layer is executing in the environment, processing the task with the instance; or
in response to determining the instance of the fine-tuned model include the layer is not executing in the environment:
retrieving the layer identified by the model instance identifier from a data store, wherein the layer is pre-trained with data associated with the task;
loading the layer into a base model to generate the instance of the fine-tuned model, the base model pre-trained on a general dataset;
initiating the environment with the instance of the fine-tuned model comprising the layer; and
processing the task with the instance of the fine-tuned model.

15. The computer-readable storage medium of claim 1, comprising the instructions to cause the processor to store a plurality of layers including the layer in the data store, wherein each of the plurality of layers is identified with a different model instance identifier.

16. The computer-readable storage medium of claim 15, wherein each of the plurality of layers is pre-trained with one of a plurality of base models.

17. The computer-readable storage medium of claim 1, comprising identifying, by the orchestration platform, the base model with a model identifier.

18. A computing apparatus comprising:
a processor; and
a memory storing instructions that, when executed by the processor, the processor to perform:
executing a base model in an environment in a cluster system;
loading one or more layers into a cache of the cluster system;
receiving a request to perform a task, the request comprising a model instance identifier associated with a specific layer;
identifying the specific layer from the one or more layers loaded into the cache of the cluster;
loading the specific layer into the base model to generate a fine-tuned model to process the task; and
processing the task to determine a request including one or more inferences.

19. The computing apparatus of claim 18, wherein the base model is trained on a general dataset, and the specific layer is trained with the base model with a specific dataset.

20. The computing apparatus of claim 18, wherein the cache is host-level cache or cluster level cache.
